(19) United States
(12) Patent Application Publication
(10) Pub. No.: US 2007/0067468 A1
(43) Pub. Date: Mar. 22, 2007

(54) Information processing apparatus, and method, program recording medium, and program

(76) Inventors: Kenji Hyodo, TOKYO (JP); Hideaki Mita, Hyogo (JP)

Correspondence Address: William S Frommer;Frommer Lawrence & Haug, 745 Fifth Avenue, New York, NY, 10151, US

(21) Appl. No.: 10/556,414

(22) PCT Filed: May 12, 2004
(86) PCT No.: PCT/JP04/06673

§ 371 Date: May 22, 2006

(30) Foreign Application Priority Data
May 12, 2003 (JP) 2003-132504

(51) Int. Cl. G06F 15/16

(52) U.S. Cl. 709/230

(57) ABSTRACT

Files are capable of being exchanged between a broadcast device and a personal computer. In a file of an AV multiplex format, a header (size and type information) of a skip atom of QT is described at the beginning (run-in) that is ignored in an MXF file. An MXF header is described in the skip atom that is skipped over in a QT file. A movie atom and a mdat header of QT are described in a filler that is ignored in the MXF file. In other words, a file header portion of the AV multiplex format satisfies both the structure of the MXF file and the structure of the QT file. With this file structure, a file of the AV multiplex format can be recognized by both an MXF standard basis edit device and a QT software installed PC. The present invention can be applied to a picture record device.

### TECHNICAL FIELD

The present invention relates to an information process apparatus and method, a program record medium, and a program, in particular, to those that allow a file to be exchanged between a broadcast device and a personal computer.

### BACKGROUND ART

In recent years, communication protocols and so forth have been standardized and the prices of communication devices have been decreased. As a result, personal computers that are standardly equipped with a communication I/F (interface) have become common.

Besides personal computers, business-use broadcast devices such as AV (Audio Visual) servers and VTRs (Video Tape Recorders) that are standardly equipped with a communication I/F or that are capable of being equipped therewith have become common. Among these broadcast devices, files of video data and audio data (hereinafter they are together referred to as AV data) are exchanged.

However, in the related art, the format of files exchanged among broadcast devices depends on their models and manufacturers. Thus, it is difficult to exchange files between broadcast devices whose models are different and that are manufactured by different manufacturers. To solve this problem, as a file exchange format, MXF (Material exchange Format) was proposed in for example Patent Document WO02/21845A1 and is being standardized.

However, since the MXF files have a format proposed to exchange them among broadcast devices of different models and different manufacturers. Thus, the MXF files cannot be recognized by general purpose computers such as personal computers. In other words, files cannot be exchanged between a business-use broadcast device and a personal computer.

### DISCLOSURE OF THE INVENTION

The present invention was made from the above mentioned point of view. An object of the present invention is to exchange a file between a broadcast device and a personal computer.

A first information process apparatus according to the present invention comprises body generation means for generating a body with input data; obtainment means for obtaining the size of the input data; table generation means for generating table information with which the input data are read according to the size obtained by the obtainment means; header generation means for generating a header including the table information generated by the table generation means; and file generation means for connecting a footer to the end of the body and connecting the header generated by the header generation means to the beginning of the body to generate a file.

The format may be MXF (Material exchange Format).

The input data may be lower resolution data than main data.

The first information process apparatus may further comprise body record means for recording the body generated by the body generation means to a record medium; footer record means for recording the footer after the body recorded on the record medium by the body record means; and header record means for recording the header before the body recorded on the record medium by the body record means.

The first information process apparatus may further comprise transmission means for transmitting the file generated by the file generation means to another information process apparatus through a network; reception means for receiving meta data according to the file transmitted by the transmission means from the other information process apparatus through the network; and meta data record means for recording the meta data received by the reception means to the record medium.

A first information process method according to the present invention comprises the steps of generating a body with input data; obtaining the size of the input data; generating table information with which the input data are read according to the size obtained by a process of the obtainment step; generating a header including the table information generated by a process of the table generation step; and connecting a footer to the end of the body and connecting the header generated by a process of the header generation step to the beginning of the body to generate a file.

A first program record medium according to the present invention, a program being recorded on the first program record medium, the program comprising the steps of generating a body with input data; obtaining the size of the input data; generating table information with which the input data are read according to the size obtained by a process of the obtainment step; generating a header including the table information generated by a process of the table generation step; and connecting a footer to the end of the body and connecting the header generated by a process of the header generation step to the beginning of the body to generate the file.

A first program according to the present invention comprises the steps of generating a body with input data; obtaining the size of the input data; generating table information with which the input data are read according to the size obtained by a process of the obtainment step; generating a header including the table information generated by a process of the table generation step; and connecting a footer to the end of the body and connecting the header generated by a process of the header generation step to the beginning of the body to generate the file.

A second information process apparatus according to the present invention comprises body generation means for generating a body with input data; obtainment means for obtaining the size of the input data; table generation means for generating table information with which the input data are read according to the size obtained by the obtainment means; and file generation means for connecting a footer and the table information generated by the table generation means to the end of the body and connecting the header to the beginning of the body to generate the file.

The format may be MXF (Material exchange Format).

The input data may be lower resolution data than main data.

The second information process apparatus may further comprise body record means for recording the body generated by the body generation means to a record medium; footer record means for recording the footer and the table information after the body recorded on the record medium by the body record means; and header record means for recording the header before the body recorded on the record medium by the body record means.

The second information process apparatus may further comprise transmission means for transmitting the file generated by the file generation means to another information process apparatus through a network; reception means for receiving meta data according to the file transmitted by the transmission means from the other information process apparatus through the network; and meta data record means for recording the meta data received by the reception means to the record medium.

A second information process method according to the present invention comprises the steps of generating a body with input data; obtaining the size of the input data; generating table information with which the input data are read according to the size obtained by a process of the obtainment step; and connecting a footer and the table information generated by a process of the table generation step to the end of the body and connecting the header to the beginning of the body to generate the file.

A second program record medium according to the present invention, a program being recorded on the second program record medium, the program comprising the steps of generating a body with input data; obtaining the size of the input data; generating table information with which the input data are read according to the size obtained by a process of the obtainment step; and connecting a footer and the table information generated by a process of the table generation step to the end of the body and connecting the header to the beginning of the body to generate the file.

A second program according to the present invention comprises the steps of generating a body with input data; obtaining the size of the input data; generating table information with which the input data are read according to the size obtained by a process of the obtainment step; and connecting a footer and the table information generated by a process of the table generation step to the end of the body and connecting the header to the beginning of the body to generate the file.

According to a first aspect of the present invention, a body is generated with input data. The size of the input data is obtained. According to the obtained size, table information with which the input data are read is generated. A header containing the generated table information is generated. A footer is connected to the end of the body. The header is connected to the beginning of the body. As a result, a file is generated.

According to a second aspect of the present invention, a body is generated with input data. The size of the input data is obtained. According to the obtained size, table information with which the input data are read is generated. A footer and the table information are connected to the end of the body. A header is connected to the beginning of the body. As a result, a file is generated.

### BRIEF DESCRIPTION OF DRAWINGS

FIG. 1 is a schematic diagram showing an example of the structure of an AV network system according to the present invention;

FIG. 2 is a block diagram showing an example of the structure of a picture record device,

FIG. 3 is a schematic diagram showing an example of the structure of a file of an AV multiplex format used in the AV network system shown in FIG. 1,

FIG. 4 is a schematic diagram showing another example of the structure of the file of the AV multiplex format;

FIG. 5 is a schematic diagram showing an example of the structure of a file header portion of the AV multiplex format shown in FIG. 4;

FIG. 6 is an example of the structure of a movie atom shown in FIG. 5;

FIG. 7 is a schematic diagram showing an example of the structure of a time sample atom shown in FIG. 6;

FIG. 8 is a schematic diagram showing an example of the structure of a synchronization atom shown in FIG. 6;

FIG. 9 is a schematic diagram showing an example of the structure of a sample chunk atom shown in FIG. 6;

FIG. 10 is a schematic diagram showing an example of the structure of a sample size atom shown in FIG. 6;

FIG. 11 is a schematic diagram showing an example of the structure of a chunk offset atom shown in FIG. 6;

FIG. 12 is a schematic diagram showing an example of the structure of a file body portion of the AV multiplex format shown in FIG. 4;

FIG. 13 is a schematic diagram showing an example of the structure of a sound item shown in FIG. 12;

FIG. 14 is a schematic diagram showing another example of the structure of the file body portion of the AV multiplex format shown in FIG. 4;

FIG. 15 is a schematic diagram showing an example of the structure of a picture item shown in FIG. 12;

FIG. 16 is a schematic diagram describing a generation process of a conventional QT file;

FIG. 17 is a flow chart describing a generation process of a file of the AV multiplex format shown in FIG. 4;

FIG. 18 is a flow chart describing a generation process of a file footer portion and a file header portion at step S5 shown in FIG. 17;

FIG. 19 is a schematic diagram showing another example of the structure of the file of the AV multiplex format shown in FIG. 4;

FIG. 20 is a schematic diagram showing a further example of the structure of the file of the AV multiplex format shown in FIG. 4;

FIG. 21 is a flow chart describing a generation process of the file of the AV multiplex format shown in FIG. 20;

FIG. 22 is a schematic diagram showing another example of the structure of the AV network system according to the present invention;

FIG. 23 is a flow chart describing a process of the AV network system shown in FIG. 22.

### BEST MODES FOR CARRYING OUT THE INVENTION

Next, embodiments of the present invention will be described. The relationship between the structural elements described in the claims and the embodiments of the present patent application is as follows. This relationship represents that examples that support the claims of the present patent application are described in the embodiments of the present patent application. Thus, even if examples corresponding to the embodiments are not described in this section, the examples should not be construed as those that do not correspond to the structural elements of the claims of the present patent application. In contrast, even if examples are described in this section as those that correspond to the structural elements of the claims, the examples should not be construed as those that do not correspond to other than the structural elements of the claims of the present patent application.

In addition, the description of this section does not mean that all aspects of the present invention that correspond to the examples described in the embodiments of the present patent application are not described in the claims of the present patent application. In other words, this description does not deny the possibility of which there are aspects of the present invention that are described in the embodiments but not described in the claims of the present patent application, namely aspects of the present invention that may be filed as divisional patent application(s) or aspects of the present invention that may be added as amendments.

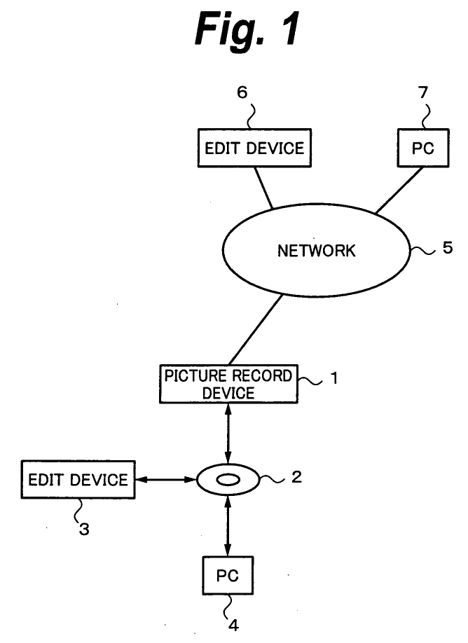

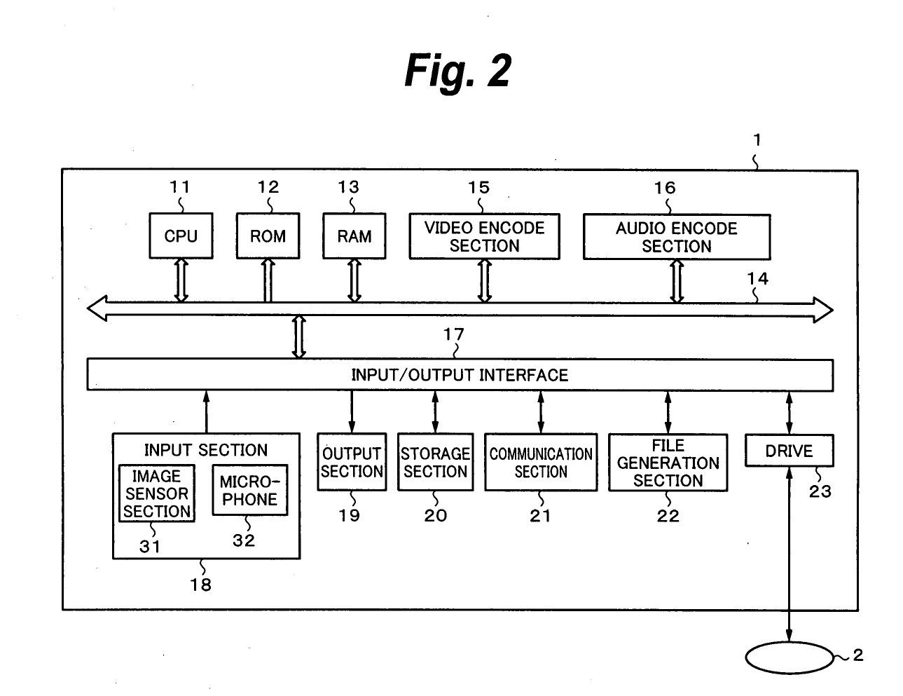

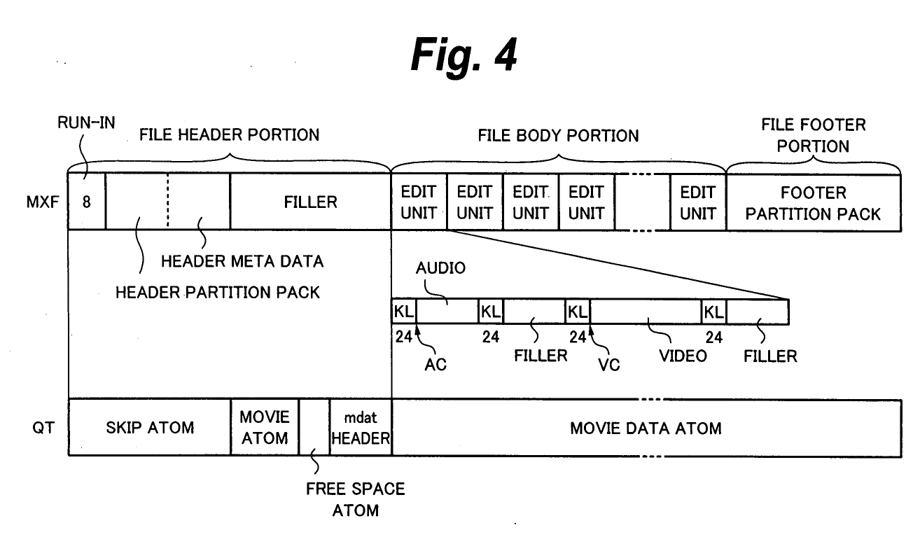

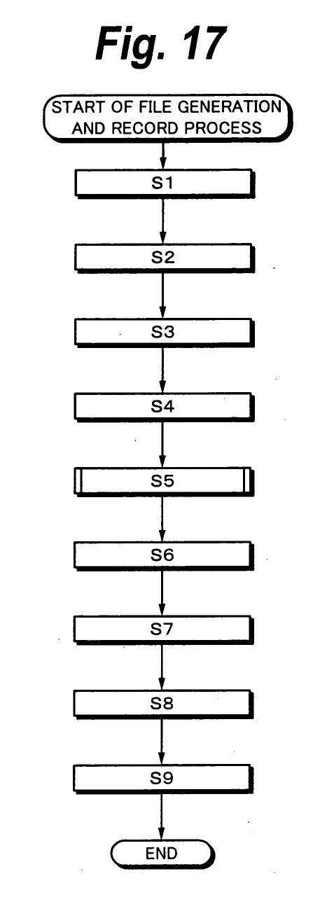

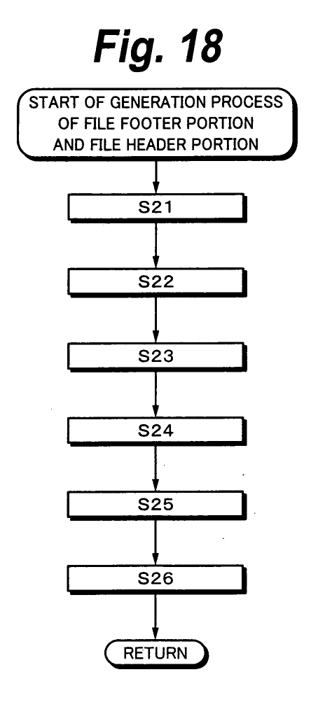

Claim 1 of the present invention is an information process apparatus (for example, a picture record apparatus 1 shown in FIG. 1) that generate a file of a format composed of a header, a body, and a footer, comprising body generation means (for example, a file generation section 22, shown in FIG. 2, that executes a process of step S1 shown in FIG. 17) for generating the body (for example, a file body portion shown in FIG. 4) with input data (for example, video data or audio data; obtainment means (for example, the file generation section 22, shown in FIG. 2, that executes a process of step S2 shown in FIG. 17) for obtaining the size (for example, the frame size) of the input data (for example, video data); table generation means (for example, the file generation section 22, shown in FIG. 2, that executes a process of step S26 shown in FIG. 18) for generating table information (for example, a movie atom shown in FIG. 4) with which the input data are read according to the size obtained by the obtainment means; header generation means (for example, the file generation section 22 that executes processes of steps S24 to S26 shown in FIG. 18) for generating the header including the table information generated by the table generation means; and file generation means (for example, the file generation section 22, shown in FIG. 2, that executes processes of steps S6 and S8 shown in FIG. 17) for connecting the footer (for example, a file footer portion shown in FIG. 4) to the end of the body and connecting the header (for example, a file header portion shown in FIG. 4) generated by the header generation means to the beginning of the body to generate the file.

Claim 4 of the present invention is the information process apparatus further comprising body record means (for example, a drive 23, shown in FIG. 2, that executes a process of step S4 shown in FIG. 17) for recording the body generated by the body generation means to a record medium (for example, an optical disc 2 shown in FIG. 1); footer record means (for example, the drive 23, shown in FIG. 2, that executes a process of step 7 shown in FIG. 17) for recording the footer after the body recorded on the record medium by the body record means; and header record means (for example, the drive 23, shown in FIG. 2, that executes a process of step S9 shown in FIG. 17) for recording the header before the body recorded on the record medium by the body record means.

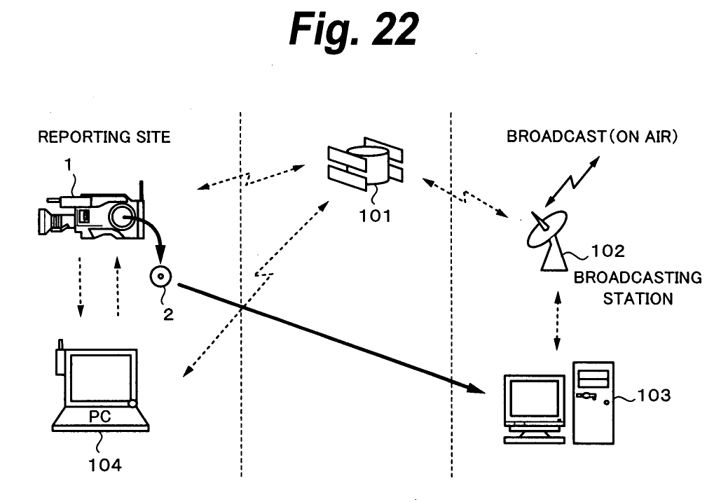

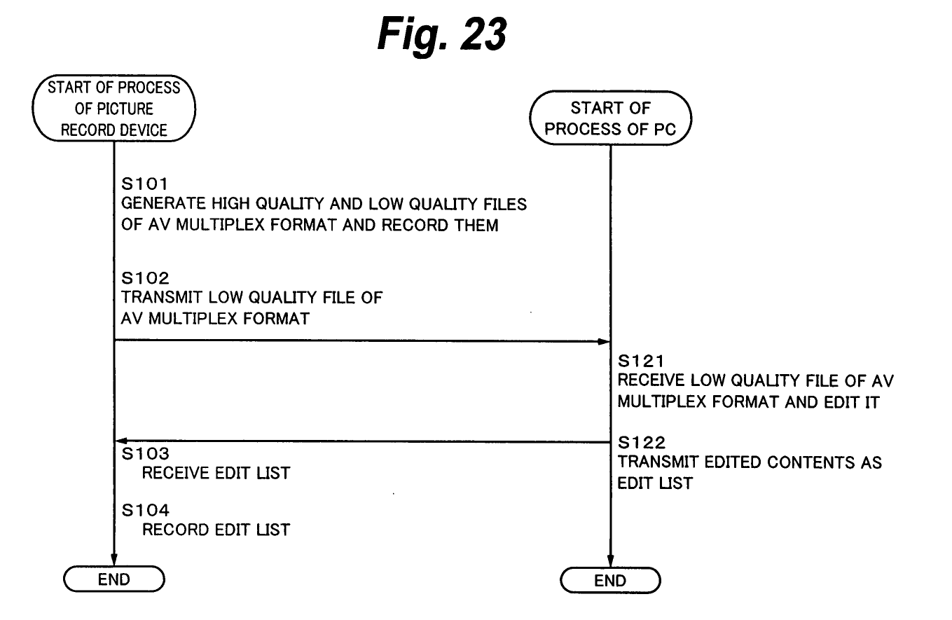

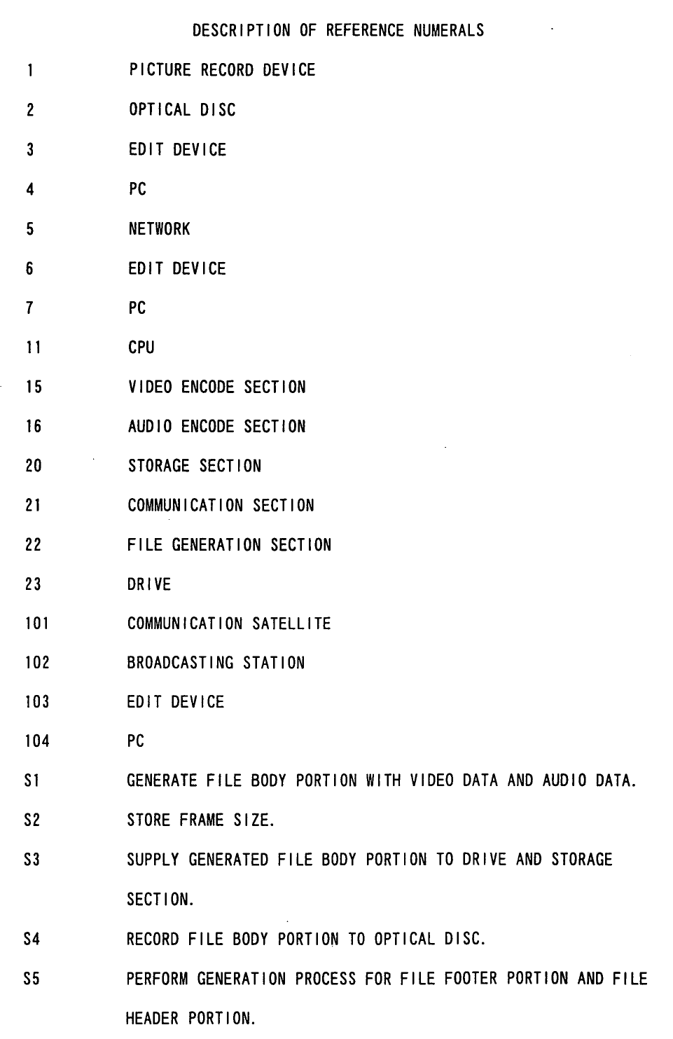

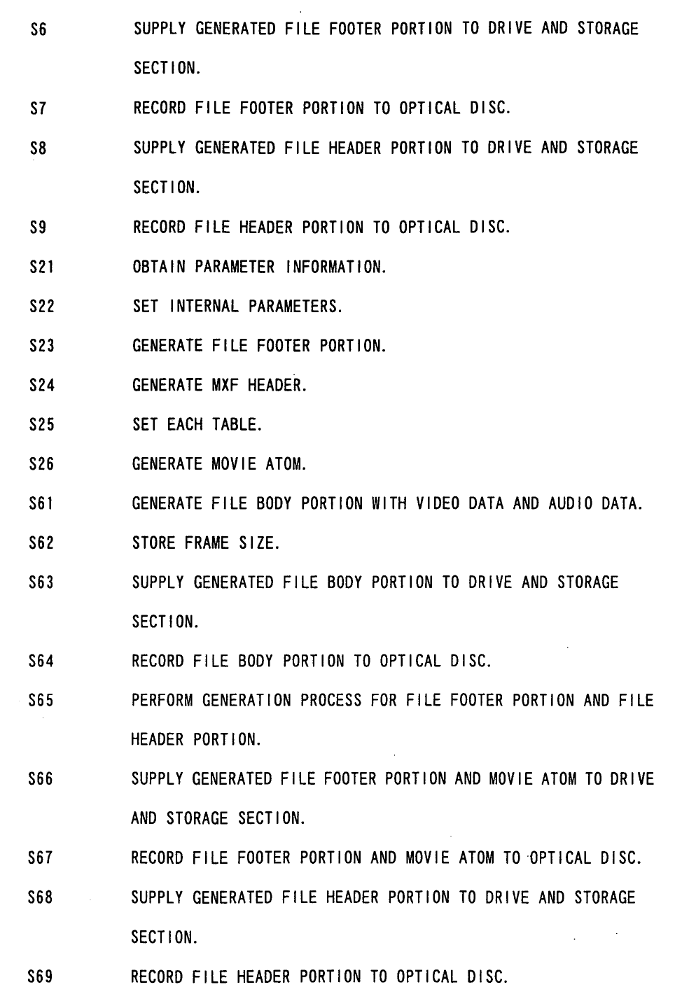

Claim 5 of the present invention is the information process apparatus further comprising transmission means (for example, a communication section 21, shown in FIG. 2, that executes a process of step S102 shown in FIG. 23) for transmitting the file generated by the file generation means to another information process apparatus (for example, a PC 104 shown in FIG. 22) through a network (for example, a communication satellite 101 shown in FIG. 22); reception means (for example, the communication section 21, shown in FIG. 2, that executes a process of step S103 shown in FIG. 23) for receiving meta data (for example, an edit list) according to the file transmitted by the transmission means from the other information process apparatus through the network; and meta data record means (for example, the drive 23, shown in FIG. 2, that executes a process of step S104 shown in FIG. 23) for recording the meta data received by the reception means to the record medium (for example, the optical disc 2 shown in FIG. 22).

A first information process method, a first program record medium, and a first program according to the present invention comprise the steps of generating a body with input data (for example, step S1 shown in FIG. 17); obtaining the size of the input data (for example, step S2 shown in FIG. 17); generating table information with which the input data are read according to the size obtained by a process of the obtainment step (for example, step S26 shown in FIG. 18); generating a header including the table information generated by a process of the table generation step (for example, steps S24 to S26 shown in FIG. 18); and connecting a footer to the end of the body and connecting the header generated by a process of the header generation step to the beginning of the body to generate a file (for example, steps S6 and S8 shown in FIG. 17).

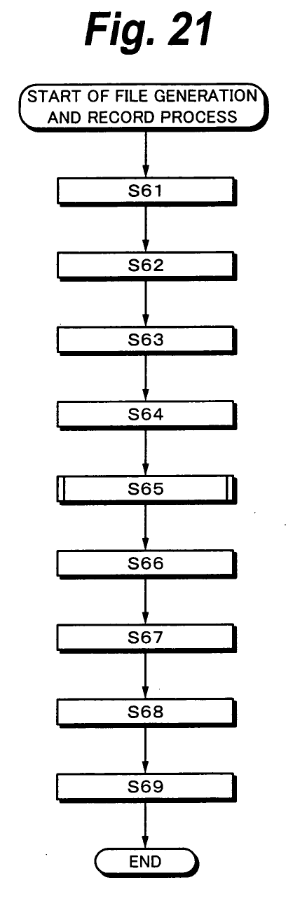

Claim 9 of the present invention is an information process apparatus comprising body generation means (for example, the file generation section 22, shown in FIG. 2, that executes a process of step S61 shown in FIG. 21) for generating a body with input data; obtainment means (for example, the file generation section 22, shown in FIG. 2, that executes a process of step S62 shown in FIG. 21) for obtaining the size of the input data; table generation means (for example, the file generation section 22, shown in FIG. 2, that executes a process of step S26 shown in FIG. 18) for generating table information with which the input data are read according to the size obtained by the obtainment means; and file generation means (for example, the file generation section 22, shown in FIG. 2, that executes processes of steps S66 and S68 shown in FIG. 21) for connecting a footer and the table information generated by the table generation means to the end of the body and connecting a header to the beginning of the body to generate a file.

Claim 12 of the present invention is the information process apparatus further comprising body record means (for example, the drive 23, shown in FIG. 2, that executes a process of step S64 shown in FIG. 21) for recording the body generated by the body generation means to a record medium (for example, the optical disc 2 shown in FIG. 1); footer record means (for example, the drive 23, shown in FIG. 2, that executes a process of step S67 shown in FIG. 21) for recording the footer and the table information after the body recorded on the record medium by the body record means; and header record means (for example, the drive 23, shown in FIG. 2, that executes a process of step S69 shown in FIG. 21) for recording the header before the body recorded on the record medium by the body record means.

Claim 13 of the present invention is the information process apparatus further comprising transmission means (for example, the communication section 21, shown in FIG. 2, that executes a process of step S102 shown in FIG. 23) for transmitting the file generated by the file generation means to another information process apparatus through a network; reception means (for example, the communication section 21, shown in FIG. 2, that executes a process of step S103 shown in FIG. 23) for receiving meta data according to the file transmitted by the transmission means from the other information process apparatus through the network; and meta data record means (for example, the drive 23 shown in FIG. 2, that executes a process of step S104 shown in FIG. 23) for recording the meta data received by the reception means to the record medium.

A second information process method, a second program record medium, and a second program according to the present invention comprise the steps of generating a body with input data (for example, step S61 shown in FIG. 21); obtaining the size of the input data (for example, step S62 shown in FIG. 21; generating table information with which the input data are read according to the size obtained by a process of the obtainment step (for example, step S26 shown in FIG. 18); and connecting a footer and the table information generated by a process of the table generation step to the end of the body and connecting a header to the beginning of the body to generate the file (for example, steps S66 and S68 shown in FIG. 21).

Next, with reference to the accompanying drawings, embodiments of the present invention will be described.

FIG. 1 shows an example of the structure of an AV network system (a system is a logical set of a plurality of devices regardless of whether they are contained in one housing) according to an embodiment of the present invention.

An optical disc 2 can be loaded and unloaded to and from a picture record device 1. The picture record device 1 generates a file of an AV multiplex format, which will be described later, with captured video data of an object and collected audio data and records the generated file to the loaded optical disc 2.

In addition, the picture record device 1 reads a file of the AV multiplex format from the loaded optical disc 2 or a built-in storage section 20 (FIG. 2) and transmits the file of the AV multiplex format through a network 5.

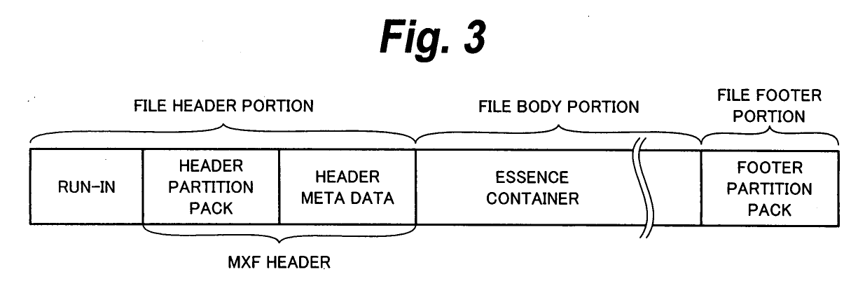

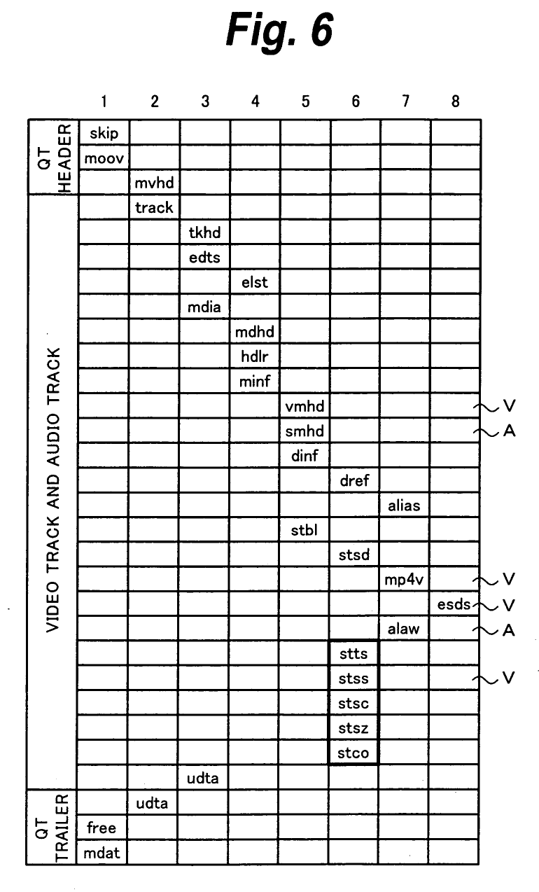

The file of the AV multiplex format is a file based on for example the MXF standard. As will be described with reference to FIG. 3 in detail, the file of the AV multiplex format is composed of a file header portion (File Header), a file body portion (File Body), and a file footer portion (File Footer). Since the file of the AV multiplex format is a file based on the MXF standard, video data and audio data that are AV data are multiplexed for e.g. 60 frames each at a time (in the case of the NTSC system) and placed at the file body portion. In addition, the file of the AV multiplex format is supported by the QT (Quick Time, registered trademark), which is a platform independent, variously formatable, and extensible software. Even if a device is not based on the MXF standard, when the device has installed the QT software, the device can reproduce and edit the file of the AV multiplex format. In other words, the file header portion of the AV multiplex format contains information (a sample table that will be described later with reference to FIG. 6) with which the QT reproduces and edits video data and audio data placed in the body based on the MXF standard.

In FIG. 1, the optical disc 2 can be loaded and unloaded to and from an edit device 3 and a PC (Personal Computer) 4. The edit device 3 is an MXF standard basis device that can handle an MXF standard-based file and can read video data and audio data from the file of the AV multiplex format recorded on the loaded optical disc 2. The edit device 3 stream-reproduces and edits video data and audio data from the file of the AV multiplex format and records the video data and audio data of the file of the AV multiplex format as an edit result to the loaded optical disc 2.

Although the PC 4 is not an MXF standard basis device, the PC 4 has installed the QT software. Thus, the PC 4 can read video data and audio data from the file of the AV multiplex format recorded on the loaded optical disc 2. In other words, the PC 4 can read video data or audio data from the file body portion of the AV multiplex format according to information that is placed in the file header portion of the AV multiplex format and that is necessary to reproduce and edit the video data or audio data with the QT and perform an edit process and other processes for the video data or audio data.

In FIG. 1, an edit device 6 connected to the network 5 is an MXF standard basis device that can handle an MXF standard basis file like the edit device 3. Thus, the edit device 6 can receive a file of the AV multiplex format from the picture record device 1 through the network 5. In addition, the edit device 6 can transmit the file of the AV multiplex format to the picture record device 1 through the network 5. In other words, the picture record device 1 and the edit device 6 can exchange the file of the AV multiplex format through the network 5. In addition, the edit device 6 can perform various processes such as a streaming reproduction and an edit process.

On the other hand, although a PC 7 connected to the network 5 is not an MXF standard basis device like the PC 4, the PC 7 has installed the QT software. Thus, the PC 7 can receive a file of the AV multiplex format from the picture record device 1 through the network 5. In addition, the PC 7 can transmit a file of the AV multiplex format to the picture record device 1 through the network 5. In other words, the PC 7 can read video data and audio data from the file body portion of the AV multiplex format according to information that is placed in the file header portion of the AV multiplex format and that is necessary to reproduce and edit the video data and audio data with the QT and perform an edit process and so forth for the video data and audio data.

Thus, the file of the AV multiplex format is an MXF standard basis file. In addition, information necessary to reproduce and edit the video file and audio file placed in the MXF standard based body portion with the QT is placed in the file header portion of the AV multiplex format. As a result, the picture record device 1 can have compatibility with not only with the edit devices 3 and 6, but the general purpose PCs 4 and 7.

In other words, the picture record apparatus 1, the edit devices 3 and 6, which are MXF standard basis devices, and the QT software installed PCs 4 and 7 can exchange a file of the AV multiplex format thereamong.

FIG. 2 shows an example of the structure of the picture record device 1 according to the present invention. In FIG. 2, a CPU (Central Processing Unit) 11 executes various processes according to a program stored in a ROM (Read Only Memory) 12 or a program loaded from a storage section 20 to a RAM (Random Access Memory) 13. The RAM 13 also stores data and so forth with which the CPU 11 execute various processes.

The CPU 11, the ROM 12, and the RAM 13 are connected to each other through a bus 14. A video encode section 15, an audio encode section 16, and an input/output interface 17 are connected to the bus 14.

The video encode section 15 encodes video data inputted from an image capture section 31 according to the MPEG (Moving Picture Experts Group) 4 system and supplies the encoded video data to the storage section 20 or a file generation section 22. The audio encode section 16 encodes audio data inputted from a microphone 32 according to the ITU-T G. 711 A-Law system and supplies the encoded audio data to the storage section 20 or the file generation section 22. In this case, the video encode section 15 encodes the input video data and outputs lower resolution video data than the input video data. However, the video encode section 15 can encode the input video data and output video data whose resolution depends on the desired quality, file capacity, and so forth. Likewise, the audio encode section 16 encodes the input audio data and outputs lower quality audio data than the input audio data. However, the audio encode section 16 can encode the input audio data and output audio data whose quality depends on the desired quality, file capacity, and so forth.

Connected to the input/output interface 17 are an input section 18 composed of an image sensor section 31 that captures an image of an object and inputs video data of the captured image, the microphone 32, and so forth, an output section 19 composed of a monitor that is a CRT (Cathode Ray Tube), an LCD (Liquid Crystal Display), or the like, a speaker, and so forth, the storage section 20, a communication section 21, the file generation section 22, and a drive 23.

The storage section 20 is composed of a memory, a hard disk, and so forth. The storage section 20 stores video data supplied from the video encode section 15 and audio data supplied from the audio encode section 16. In addition, the storage section 20 temporarily stores a file of the AV multiplex format, which will be described later in detail, supplied from the file generation section 22. Specifically, the storage section 20 stores a file body portion supplied from the file generation section 22 under the control of the file generation section 22, connects a file footer portion to the end of the file body portion, connects the file header portion to the beginning of the file body portion, obtains a file of the AV multiplex format, and stores it.

The communication section 21 is composed of for example an IEEE (Institute of Electrical and Electronics Engineers) 1394 port, a USB (Universal Serial Bus) port, an NIC (Network Interface Card) connected to a LAN (Local Area Network), an analog modem, a TA (Terminal Adaptor), a DSU (Digital Service Unit), an ADSL (Asymmetric Digital Subscriber Line) modem, or the like. The communication section 21 exchanges a file of the AV multiplex format with the edit device 6 and the PC 7 through the network 5 such as the Internet or an intranet. In other words, the communication section 21 transmits a file of the AV multiplex format generated by the file generation section 22 and temporarily stored in the storage section 20 through the network 5 or receives the file through the network 5 and supplies the file to the output section 19 or the storage section 20.

The file generation section 22 successively generates the file body portion, the file footer portion, and the file header portion of the AV multiplex format, which will be described later in detail, with video data supplied from the video encode section 15 and audio data supplied from the audio encode section 16 and supplies them to the storage section 20 or the drive 23. In addition, the file generation section 22 successively generates the file body portion, the file footer portion, and the file header portion of the AV multiplex format, which will be described later in detail, with video data and audio data stored in the storage section 20 and supplies them to the storage section 20 or the drive 23.

The optical disc 2 can be loaded and unloaded to and from the drive 23. The drive 23 drives the loaded optical disc 2 to record the file body portion of the AV multiplex format supplied from the file generation section 22. Specifically, the drive 23 records the file footer portion after the end of the file body portion supplied from the file generation section 22 and records the file header portion before the beginning of the file body portion to record a file of the AV multiplex format to the optical disc 2. In addition, the drive 23 reads a file of the AV multiplex format from the optical disc 2 and supplies it to the output section 19 or the storage section 20.

As described above, the file generation section 22 of the picture record device 1 successively generates the file body portion, the file footer portion, and the file header portion of the AV multiplex format with video data and audio data inputted from the input section 18 or video data and audio data that are stored in the storage section 20 and supplies them to the drive 23. The drive 23 successively records the file body portion, the file footer portion, and the file header portion of the AV multiplex format in the order that they are supplied from the file generation section 22 to the loaded optical disc 2.

In addition, the file generation section 22 of the picture record device 1 successively generates the file body portion, the file footer portion, and the file header portion of the AV multiplex format with video data and audio data inputted from the input section 18 or video data and audio data that are stored in the storage section 20 and temporarily stores them as a file of the AV multiplex format to the storage section 20. The communication section 21 transmits the file of the AV multiplex format stored in the storage section 20 through the network 5.

FIG. 3 shows an example of the AV multiplex format.

A file of the AV multiplex format is based on the MXF standard described in the foregoing patent document. The file of the AV multiplex format is composed of a file header portion (File Header), a file body portion (File Body), and a file header portion (File Footer) that are successively arranged.

In the file header portion of the AV multiplex format, a run-in (Run In) and an MXF header are successively arranged. The MXF header is composed of a header partition pack and header meta data.

The run-in is an option that represents that the MXF header starts with a matched pattern of 11 bytes. The run-in can be allocated up to 64 kbytes. In this example, the run-in is 8 bytes. In the run-in, any data except for the patter of 11 bytes of the MXF header may be placed. In the header partition pack, the patter of 11 bytes, which identifies the header, the format of data placed in the file body portion, information that represents the file format, and so forth are placed. In the header meta data, information that is necessary to read video data and audio data that are AV data placed in an essence container that composes the file body portion and so forth are placed.

The file body portion of the AV multiplex format is composed of an essence container. In the essence container, video data and audio data that are AV data are multiplexed for e.g. 60 frames each at a time (in the case of the NTSC system) and placed.

The file footer portion of the AV multiplex format is composed of a footer partition pack. In the footer partition pack, data that identify the file footer portion and so forth are placed.

When the file of the AV multiplex format is supplied, the MXF standard based edit devices 3 and 6 read a pattern of 11 bytes from the header partition pack and obtains the MXF header. According to the header meta data of the MXF header, the edit devices 3 and 6 can read video data and audio data that are AV data from the essence container.

FIG. 4 shows another example of the AV multiplex format. In the example shown in FIG. 4, the upper sequence represents an example of a file of the AV multiplex format recognized by the MXF standard basis edit devices 3 and 6 described with reference to FIG. 3 (hereinafter this file of the AV multiplex format is referred to as an MXF file). The lower sequence represents an example of a file of the AV multiplex format recognized by the QT software installed PCs 4 and 7 (hereinafter this file of the AV multiplex format is referred to as a QT file). In other words, the AV multiplex format has both the structure of an QT file and the structure of an MXF file.

As shown in the upper sequence, when the file of the AV multiplex format is regarded as an MXF file, the file of the AV multiplex format is composed of a file header portion, a file body portion, and a file body portion. The file header portion is composed of a run-in of 8 bytes, an MXF header, which is composed of a header partition pack and header meta data, and a filler as stuffing data. The file body portion composed of an essence container. The file footer portion is composed of a footer partition pack.

In the example shown in FIG. 4, the essence container, which composes the file body portion, is composed of at least one edit unit. One edit unit is composed of 60 frames (in the case of the NTSC system). In one edit unit, 60 frames of AV data (audio data and video data) and so forth are placed. In one edit unit, 60 frames of AV data (in the case of the NTSC system) and so forth are encoded according in the KLV (Key, Length, Value) structure.

The KLV structure has a key, a length, and a value in the order. The key has a label of 16 bytes that is based on the SMPTE 298M standard and that represents the type of data placed in the value. In the length, the data length (8 byes) of data placed in the value according to the BER (Basic Encoding Rules: ISO/IEC8821 ASN). In the value, real data, namely 60 frames of audio data or video data are paced (in the case of the NTSC system). To cause audio data and video data to have a fixed length, a filler as stuffing data is placed after the end of each of audio data or video data as the KLV structure.

Thus, the edit unit is composed of audio data, a filler, video data, and a filler that are successively arranged in the KLV structure.

As shown in the lower sequence, when the file of the AV multiplex format is regarded as a QT file, the file of the AV multiplex format is composed of a skip atom, a movie atom, a free space atom, a mdat header that is a header of the movie data atom, and a movie data atom that are successively arranged.

A QT movie resource has a basic data unit that is referred to as an atom. Each atom has a header composed of a size of 4 bytes and type information of 4 bytes.

The skip atom is an atom whose data are skipped over. As will be described later with reference to FIG. 6, the movie atom describes a sample table and so forth. The sample table is information with which AV data recorded in the movie data atom are read. Most of information described in the movie atom is fixed information. The free space atom is an atom that forms a space in the file. Since the file header portion is formed in the unit of one ECC (Error Correcting Code), the file body portion starts with the boundary of one ECC. In other words, the free space atom is used to adjust the size of ECCs of the file header portion. The movie data atom is a portion in which real data such as video data and audio data are stored.

Thus, in the file of the AV multiplex format shown in FIG. 4, the header (size and type information) of the skip atom of the QT file is described at the beginning (run-in) of the file, which is ignored in the MXF file. The MXF header is described in the skip atom, which is skipped over in the QT file. In addition, the movie atom and the mdat header are described in the filler, which is ignored in the MXF file. In other words, the file header portion of the AV multiplex format satisfies both the structure of the MXF file and the structure of the QT file.

In addition, the file body portion and the file footer portion of the MXF file correspond to the movie data atom of the QT file. The minimum unit of video data and audio data placed in the movie data atom of the QT file is referred to as a sample. As a set of samples, a chunk is defined. In other words, in the QT file, audio data and video data placed in one edit unit are recognized as one chunk. Thus, in the QT file, the key and length corresponding to audio data of the edit unit are ignored. The start position AC of audio data is recognized as the start position AC of a chunk. According to the start position AC, information necessary to read the audio data is described in the movie atom. Likewise, the key and length corresponding to video data of the edit unit are ignored. The start position VC of video data is recognized as the start position VC of a chunk. According to the start position VC, information necessary to read the video data is described in the movie atom.

In this file structure, not only the MXF standard basis edit devices 3 and 6, but the QT software installed PCs 4 and 7 recognize the file of the AV multiplex format and read audio data and video data from the file body portion.

In other words, the MXF standard basis edit devices 3 and 6 ignore the run-in, read the 11-byte pattern of the header partition pack, and obtain the MXF header. According to the header meta data of the MXF header, the edit devices 3 and 6 can read video data and audio data that are AV data from the essence container.

On the other hand, the QT software installed PCs 4 and 7 recognize the header of the skip atom, skip over the skip atom, and read the movie atom. According to information described in the movie atom (sample table or the like that will be described later), the PCs 4 and 7 can read a chunk (audio data or video data) recorded in the movie data atom.

Thus, the picture record device 1, the MXF standard basis edit devices 3 and 6, and the QT software installed PCs 4 and 7 can exchange files of the AV multiplex format thereamong.

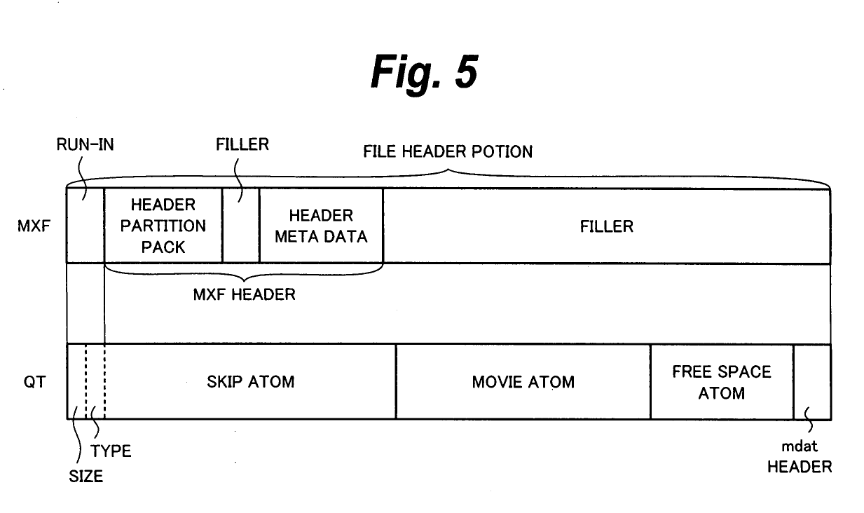

FIG. 5 shows an example of the header portion of the MXF file in the AV multiplex format in detail. In the example shown in FIG. 5, the upper sequence shows an example of a file of the AV multiplex format regarded as an MXF file, whereas the lower sequence shows an example of a file of the AV multiplex format regarded as a QT file.

In the example shown in FIG. 5, in the upper sequence, when the file of the AV multiplex format is regarded as an MXF file, the file header portion of the MXF file is composed of a run-in, an MXF header, and a filler that are successively arranged. The MXF header is composed of a header partition pack, a filler, and a header meta data that are successively arranged. On the other hand, in the lower sequence, when the file of the AV multiplex format is regarded a QT file, it is composed of a skip atom, a movie atom, a free space atom, and a mdat header that are successively arranged corresponding to the file header portion of the MXF file. The mdat header is the header of the movie data atom.

In the example shown in FIG. 5, corresponding to the run-in of the MXF file, a size and type information that are the header of the slip atom of the QT file are described. Corresponding to the MXF header preceded by the run-in of the MXF file, the skip atom of the QT file is described. Corresponding to the filler preceded by the MXF header, the movie atom, the free space atom, and the header of the movie data atom of the QT file are described.

In this structure, the MXF standard basis edit devices 3 and 6 can ignore the run-in, recognize the header partition of the MXF header, and read video data and audio data from the file body portion according to the header meta data of the MXF header. On the other hand, the QT software installed PCs 4 and 7 can recognize the header of the skip atom, skip over the skip atom, and read a chunk (video data and audio data) from the file body portion (movie data atom) preceded by the header of the movie data atom according to information described in the movie atom.

Next, with reference to FIG. 6, information described in the movie atom will be described in detail.

FIG. 6 shows an example of the structure of the QT file corresponding to the file header portion shown in FIG. 5. In the example shown in FIG. 6, the upper portion represents the beginning of the file. As described above, the basic data unit of a QT movie resource is referred to as an atom. In this case, atoms are hierarchized from hierarchical level 1 to hierarchical level 8. The leftmost column in the drawing is hierarchical level 1, which is the highest hierarchical level. “V” denoted on the right side of the drawing represents an atom described only when media with which a track atom (that will be described later) deals are video data (namely, a track atom of video data (video track atom)), whereas “A” represents an atom described only when media with which a track atom deals are audio data (namely, a track atom of audio data (audio track atom)).

In the case of the example shown in FIG. 6, the QT header of the QT file is composed of a skip atom (skip) and a movie atom (moov) of hierarchical level 1 and a movie header atom (mvhd) of hierarchical level 2. On the other hand, the trailer of the QT file is composed of a user definition atom (udta) of hierarchical level 2 and a free space atom (free) and a mdat header (mdat), which is the header of the movie data atom, of hierarchical level 1. The video track and audio track of the QT file are composed of a track atom (track) of hierarchical level 2 and atoms of hierarchical level 3 to hierarchical level 8.

The QT file of hierarchical level 1, which is the highest hierarchical level, is composed of the slip atom (akip), the movie atom (moov), the free space atom (free), and the mdat header (mdat), which is the header of the movie data atom corresponding to the file header portion. In other words, the structure of hierarchical level 1 corresponds to the file header portion shown in FIG. 5.

The movie atom of hierarchical level 2 is composed of a movie header atom (mvhd), a track atom (track), and a user definition atom (udta).

The movie header atom of hierarchical level 2 is composed of information with respect to an overall movie such as a size, type information, a time scale, and a length. There are track atoms such as video track atom and audio track atoms corresponding to media. When there are four channels of audio data, there are two audio track atoms. Likewise, when there are eight channels of audio data, there are four audio track atoms. The track atom of hierarchical level 3 is composed of a track header atom (tkhd), an edit atom (edts), a media atom (mdia), and a user definition atom (udta).

The track header atom of hierarchical level 3 is composed of characteristic information of the track atom in the movie, such as an ID number of the track atom. The edit atom is composed of an edit list atom (elst) of hierarchical level 4. The user definition atom contains information associated with the track atom.

The media atom of hierarchical level 3 is composed of a media header atom (mdhd) that describes information with respect to media (audio data or video data) recorded in the track atom, a media handler atom (hdlr: media hander reference atom) that describes information of a handler that decodes movie data (audio data or video data), and a media information atom (minf) of hierarchical level 4.

When the track atom is a video track atom (“V” denoted on the right side of the drawing), the media information atom (minf) of hierarchical level 4 is composed of a video media header atom (vmhd), a data information atom (dinf), and a sample table atom (stbl) of hierarchical level 5. On the other hand, when the track atom is an audio track atom (“A” denoted on the right side of the drawing), the media information atom (minf) of hierarchical level 4 is composed of a sound media header atom (smhd), a data information atom, and a sample data atom of hierarchical level 5.

The data information atom of hierarchical level 5 is composed of a data reference atom (drf) of hierarchical level 6. The data reference atom of hierarchical level 6 describes the position of media data with an alias of hierarchical level 7.

The sample table atom (stbl) describes table information used to read AV data from the movie data atom. The QT can read video data and audio data from the movie data atom according to the table information. As described with reference to FIG. 4, in the QT file, the minimum unit of video data and audio data recorded in the movie data atom is a sample. As a set of samples, a chunk is defined.

When the track atom is a video track atom (“V” denoted on the right side of the drawing), the sample table atom is composed of a sample description atom (stsd) and five sample tables of a time sample atom (stts: time to sample atom), a synchronization sample atom (stss: sync sample atom), a sample chunk atom (stsc: sample to chunk atom), a sample size atom (stsz), and a chunk offset atom (stco) of hierarchical level 6. When the track atom is an audio track atom (“A” denoted on the right side of the drawing), the synchronous sample atom is not described.

When media recorded on the track are video data (“V” denoted on the right side of the drawing), the sample distribution atom of hierarchical level 6 is composed of for example an MPEG data format atom (mp4v) that describes the format of MPEG4 video data of hierarchical level 7 and an element stream description atom (esds) of hierarchical level 8. The element stream description atom describes information necessary to decode data. When media recorded on the track are audio data (“A” denoted on the right side of the drawing), the sample description atom is composed of an alaw data format atom (alaw) of hierarchical level 7. The alaw data format atom describes the format of audio data according to the ITU-T G.711 A-Law system.

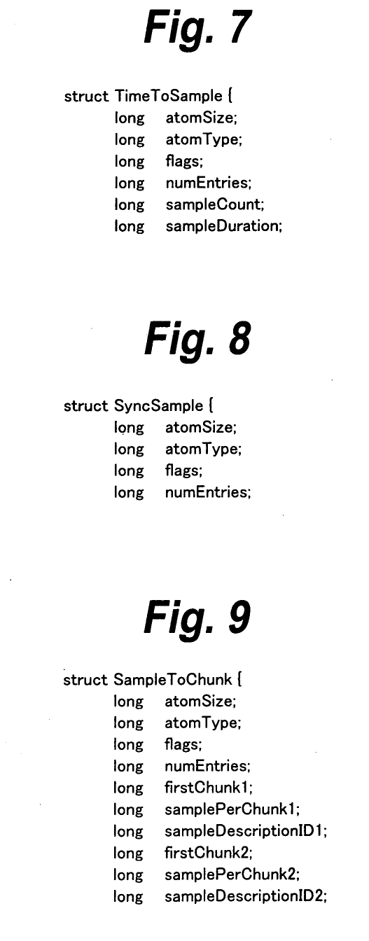

Next, with reference to FIG. 7 to FIG. 11, the five sample tables that are information used to read audio data and video data of the movie atom will be described.

FIG. 7 shows an example of the time sample atom. The time sample atom is a table that represents the relationship between one sample (one frame) and the time scale of the track atom.

In the example shown in FIG. 7, the time sample atom (stts: time to sample atom) is composed of elements atom size (atom Size), atom type (atom Type), flag (falgs), entry (num Entries), number of samples (sample Count), and sample time (sample Duration). The element atom size represents the size of the time sample atom. The element atom type represents that the atom type is “stts” (time sample atom). The first byte of the element flag represents the version and the rest of the element flag represents the flag itself. The element entry represents the number of samples and the intervals of the samples. The element “number of samples” represents the number of samples of the track atom. The element sample time represents the duration of one sample.

When the element sample time (sample Duration) described in the time sample atom is “0x64” (in hexadecimal notation), it is 100 in the time scale of the track atom. Thus, in this case, assuming that one second is set at 2997, one second is 2997/100=29.97 samples (frames).

FIG. 8 shows an example of the synchronization sample atom. The synchronization atom is a table of frame key frames as keys. The synchronization atom describes information with respect to synchronization.

In the case of the example shown in FIG. 8, the synchronization sample atom (stss: sync sample atom) is composed of elements atom size (atom Size), atom type (atom Type), flag (flags), and entry (num Entries). The element atom size represents the size of the synchronization sample atom. The element atom type represents that the atom type is “stss” (synchronization sample atom). The first byte of the element flag represents the version and the rest of the element flag represents the flag itself. The element entry represents the number of entries of the sample number table of an I frame of video data.

When there are an I picture, a P picture, and a B picture in a frame according to for example MPEG, the sample number table is a table that describes the sample numbers of I picture frames. When the track atom is an audio track atom, the synchronization sample atom is not described (“A” denoted on the right side of the drawing).

FIG. 9 shows an example of the sample chunk atom. The sample chunk atom is a table that represents the relationship between chunks and samples (frames) of which the chunks are composed.

In the example shown in FIG. 9, the sample chunk atom (stsc: sample to chunk atom) is composed of elements atom size (atom Size), atom type (atom Type), flag (flags), entry (num Entries), first chunk 1 (first Chunk1), number of samples of chunk 1 (sample Per Chunk1), entry number of chunk 1 (sample Description ID1), first chunk 2 (first chunk2), number of samples of chunk 2 (sample Per Chunk2), and entry number of chunk 2 (sample Description ID2).

The element atom size represents the size of the sample chunk atom. The element atom type represents that the atom type is “stsc” (sample chunk atom). The first byte of the element flag represents the version and the rest of the element flag represents the flag itself. The element entry represents the number of data entries.

The element first chunk 1 represents the first chunk number of the chunk group, each chunk being composed of the same number of samples. The element “number of samples of chunk 1” represents the number of samples of the chunk 1. The element “entry number of chunk 1” represents the entry number of the chunk 1. When the next chunk is a chunk whose number of samples is different from that of the chunk 1, as information with respect to the next chunk, the element first chunk 2, the element “number of samples of chunk 2,” and the element “entry number of chunk 2” are described like the element first chunk 1, the element “number of samples of chunk 1,” and the element “entry number of chunk 2.”

As described above, in the sample chunk atom, information with respect to a plurality of chunks each of which is composed of the same number of samples is described in information with respect to the first chunk that is composed of the same number of samples.

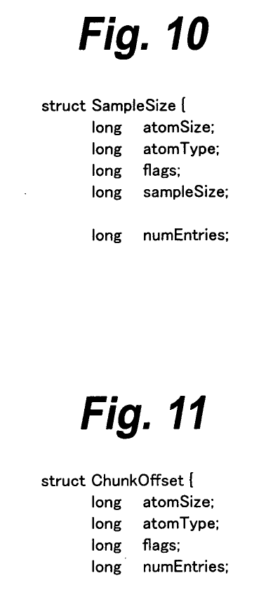

FIG. 10 shows an example of the sample size atom. The sample size atom is a table that describes the relationship between samples and their data sizes.

In the example shown in FIG. 10, the sample size atom (stsz) is composed of elements atom size (atom Size), atom type (atom Type), flag (flags), sample size (sample Size), and number of entries (num Entries). The element atom size represents the size of the sample size atom. The element atom type represents that the atom type is “stsz” (sample size atom). The first byte of the element flag represents the version and the rest of the element flag represents the flag itself. The element sample size represents the sizes of the samples. When the sizes of all samples are the same, only one size needs to be described in the element sample size. The element “number of entries” represents the number of entries of the sample size.

Thus, when the data size is constant as with audio data, a default size is described in the element sample size. On the other hand, when frames correspond to samples as with video data and the sizes of the samples vary time by time as with I pictures and P pictures according to the MPEG, the sizes of all the samples are described in the element sample size.

FIG. 11 shows an example of the chunk offset atom. The chunk offset atom is a table that represents the relationship between chunks and their offset values from the beginning of the file.

In the case of the example shown in FIG. 11, the chunk offset atom (stco) is composed of elements atom size (atom Size), atom type (atom Type), flag (flags), and number of entries (num Entries). The element atom size represents the size of the sample size atom. The element atom type represents that the atom type is “stco” (chunk offset atom). The first byte of the element flag represents the version and the rest of the element flag represents the flag itself. The element “number of entries” represents the number of entries of offset values of chunks.

Thus, for example, in the example shown in FIG. 4, as an offset value of a chunk of audio data, an offset value from the beginning of the file to the chunk start position AC is described. As an offset value of a chunk of video data, an offset value from the beginning of the file to the chunk start position VC is described.

In the movie atom that has the foregoing structure, the QT causes the media handler atom (hdlr: media handler reference atom) of hierarchical level 4 corresponding to either audio data or video data to access media data corresponding to predetermined time. Specifically, when particular sample time is given, the media handler atom decides time according to the time scale of the media. Since the media handler atom knows time in the time scale of each track atom with information of the edit atom (edts) of hierarchical level 3, the media handler atom obtains a sample number according to the time sample atom of hierarchical level 6 and obtains offset values of the chunks from the beginning of the file from the chunk offset atom of hierarchical level 6. Thus, since the media handler atom accesses the designated sample, the QT can reproduce real data according to the time scale.

As described above, the movie atom describes the sample tables that are information necessary to read video data and audio data from the movie data atom. Thus, when the movie atom is placed at the header portion of the AV multiplex format, the QT can recognize the AV multiplex format.

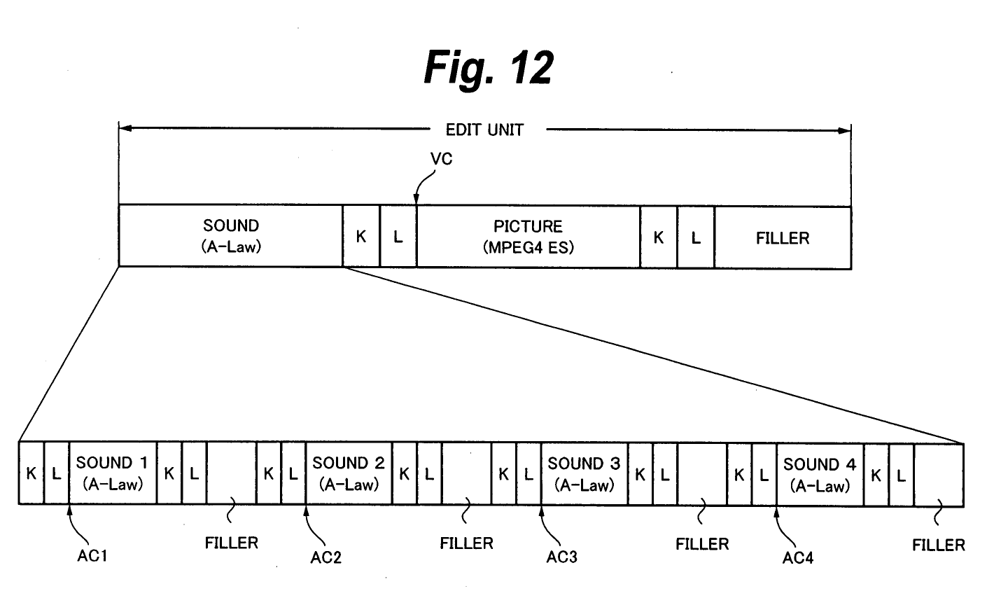

FIG. 12 shows an example of the file body portion of the MXF file in the AV multiplex format shown in FIG. 4. In the example shown in FIG. 12, one edit unit is shown.

In the example shown in FIG. 12, one edit unit is composed of a sound item (Sound), a picture item (Picture), and a filler (hereinafter, the sound item is referred to as a sound item group to distinguish it from a plurality of sound items 1 to 4).

In the sound item group, audio data corresponding to 60 frames of video data (in the case of the NTSC system) corresponding to video data placed in a picture item are divided into four blocks in the foregoing KLV structure described with reference to FIG. 4. In the case of the example shown in FIG. 12, audio data that have been encoded according to the ITU-TG. 711 A-Law system are placed in the sound item group.

Thus, the sound item group is composed of sound item 1, filer, sound item 2, filler, sound item 3, filler, sound item 4, and filler that are successively arranged in the KLV structure. One sound item is composed in the unit of ECC/2. As stuffing data that cause a sound item to be placed in a fixed length and in the unit of one ECC unit, a filler is placed.

In the picture item preceded by audio data of the sound item group, video data (elementary stream (ES)) encoded according to the MPEG (Moving Picture Experts Group) 4 system are placed in the unit of one GOP (Group Of Picture) and in the KLV structure. As stuffing data that cause the picture item to be placed in a fixed length and in the unit of ECC, a filler is placed in the KLV structure after video data of the picture item.

As described above, in the AV multiplex format, the sound item group of audio data arranged in the KLV structure and picture items of video data arranged in the KLV structure are multiplexed for 60 frames each at a time (in the case of the NTSC system) according to the MXF standard. Thus, the file generation section 22 of the picture record device 1 decides the key (K) of the KLV structure and the length (L) with the encoded data amount and generates the MXF header of the file header portion of the AV multiplex format. Thus, the MXF standard basis edit devices 3 and 6 can read audio data and video data arranged in the KLV structure according to the MXF header of the header portion.

On the other hand, the QT defines audio data and video data arranged in this manner as one chunk. Thus, the file generation section 22 ignores the key (K) and the length (L) of the LKV structure, defines sound item 1, sound item 2, sound item 3, sound item 4, and picture item as chunks, obtains the offset value of start position AC1 of the sound item 1, the offset value of start position AC2 of the sound item 2, the offset value of start position AC3 of the sound item 3, the offset value of start position AC4 of the sound item 4, and the offset value of start position VC of the picture item, and generates the sample tables of the movie atom of the file header portion. Thus, the QT software installed PCs 4 and 7 can read audio data and video data as chunks with the movie atom of the file header portion.

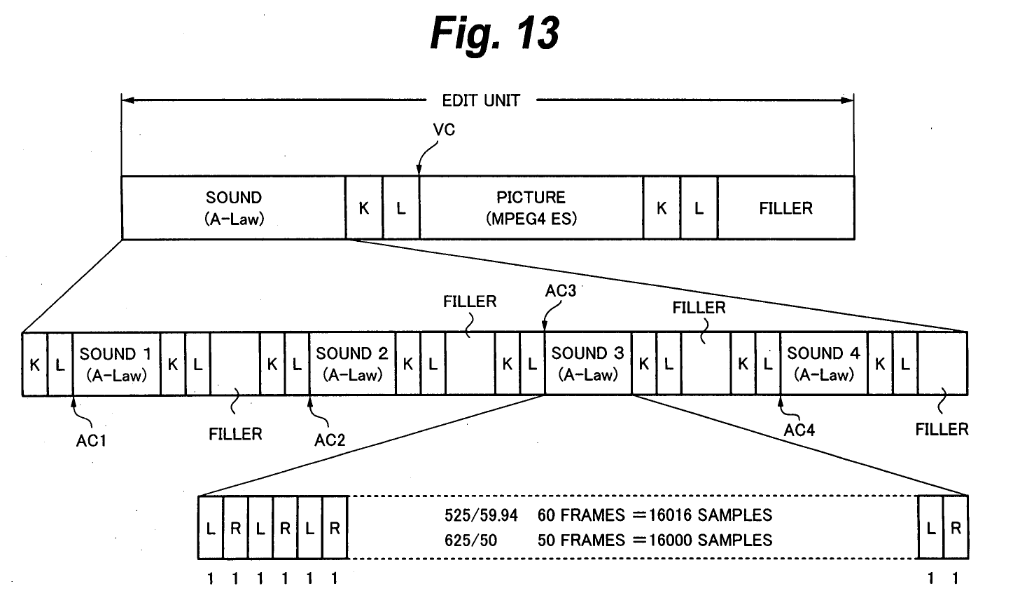

FIG. 13 shows an example of the sound item (Sound) 3 shown in FIG. 12. In the example shown in FIG. 13, the sound item 3 is composed of two channels, left and right channels, of audio data.

In other words, two channels of audio data are multiplexed by alternately arranging the two channels of audio data for each sample. Thus, according to the 525/59.94 NTSC standard, video data are composed of 60 frames. As a result, 16016 samples of audio data are arranged in a sound item. According to the 625/50 PAL standard, since video data are composed of 50 frames, 16000 samples of audio data are arranged in a sound item.

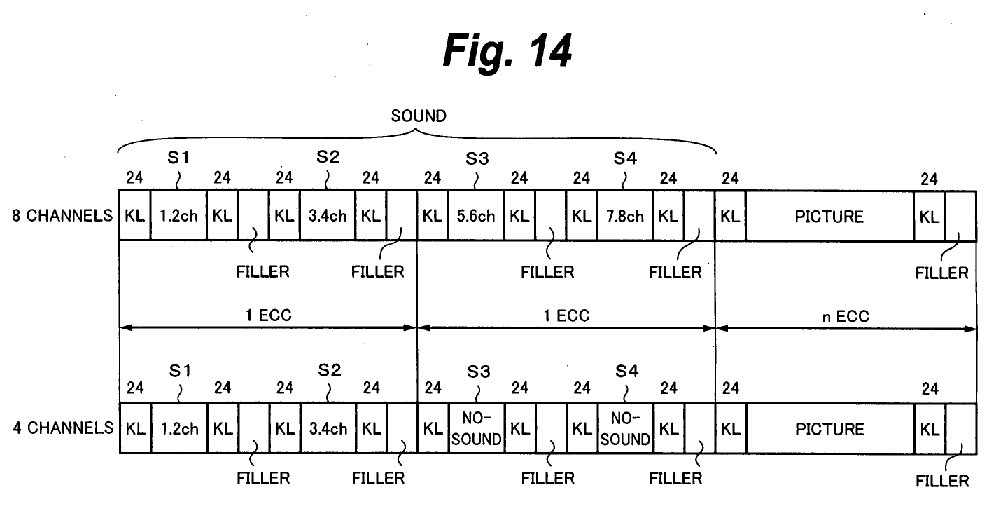

In such a manner, two channels of audio data are arranged in a sound item. Thus, next, with reference to FIG. 14, the cases of which four and eight channels of audio data are arranged in a sound item will be described.

FIG. 14 shows another example of the body portion of the AV multiplex format shown in FIG. 12. In the example shown in FIG. 14, the sound item group has a fixed length of 2 ECCs. A picture item has a fixed length of n ECCs. In this case, the upper sequence represents the file body portion in the case of eight channels of audio data. The lower sequence represents the file body portion in the case of four channels of audio data.

As shown in the upper sequence, in the case of eight channels of audio data, the first ECC of the sound item group is composed of key (K) and length (L) of 24 bytes, sound item 1 (S1) of which audio data of channel 1 and audio data of channel 2 are alternately arranged for each sample, key and length of 24 bytes, filler, sound item 2 (S2) of which audio data of channel 3 and audio data of channel 4 are alternately arranged for each sample, key and length of 24 bytes, and filler that are successively arranged. The second ECC of the sound item group is composed of key and length of 24 bytes, sound item 3 (S3) of which audio data of channel 5 and audio data of channel 6 are alternately arranged for each sample, key and length of 24 bytes, filler, key and length of 24 bytes, sound item 4 (S4) of which audio data of channel 7 and audio data of channel 8 are alternately arranged for each sample, key and length of 24 bytes, and filler that are successively arranged.

Next, as shown in the lower sequence, in the case of four channels of audio data, the first ECC of the sound item group is composed of key and length of 24 bytes, sound item 1 (S1) of which audio data of channel 1 and audio data of channel 2 are alternately arranged for each sample, key and length of 24 bytes, filler, key and length of 24 bytes, sound item 2 (S2) of which sound data of channel 3 and sound data of channel 4 are alternately arranged for each sample, key and length of 24 bytes, and filler that are successively arranged. The second ECC of the sound item group is composed of key and length of 24 bytes, sound item 3 (S3) of no-sound audio data, key and length of 24 bytes, filler, key and length of 24 bytes, sound item 4 (S4) of which no-sound audio data are alternately arranged for each sample, key and length of 24 bytes, and filler that are successively arranged.

As described above, in the case of eight channels of audio data, four channels of audio data are arranged in each of two ECCs. In the case of four channels of audio data, four channels of audio data are arranged in the first ECC, whereas no-sound audio data are recorded in sound items for four channels arranged in the second ECC.

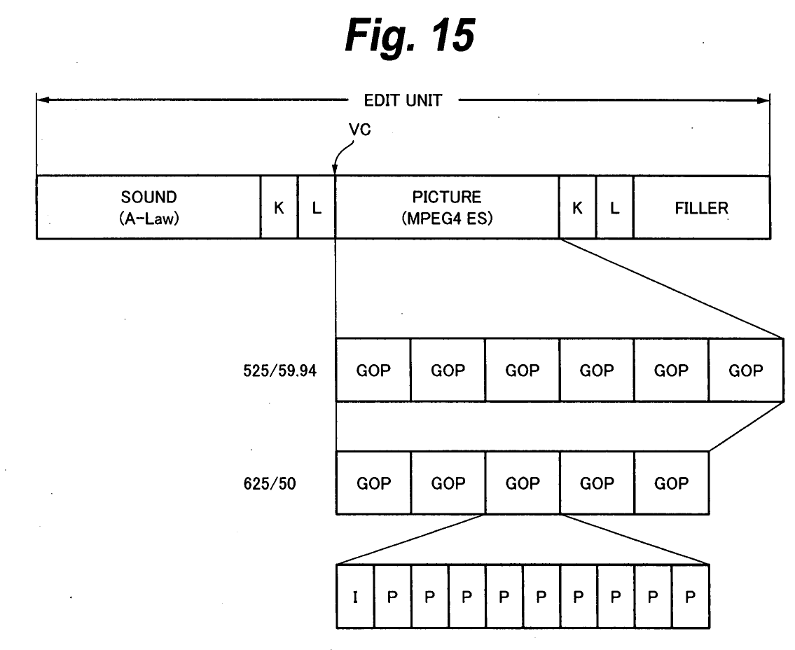

FIG. 15 shows an example of the picture item shown in FIG. 12. As described above, in the picture item, video data of 60 frames (in the case of the NTSC system)=6 GOPs (Group Of Pictures) encoded according to the MPEG4 system are arranged. Specifically, according to the 525/59.94 NTSC standard, video data are composed of 60 frames. Thus, in the picture item, six GOPs each of which is composed of one frame of I picture and nine frames of P pictures are arranged. On the other hand, according to the 625/50 PAL standard, since video data are composed of 50 frames, five GOPs each of which is composed of one frame of I picture and nine frames of P pictures are arranged in the picture item.

In such a manner, the file body portion of the AV multiplex format is arranged and structured. In the picture record device 1, the file body portion of the AV multiplex format is arranged and generated. Thereafter, according to the generated file body portion, the file footer portion and the file header portion are generated.

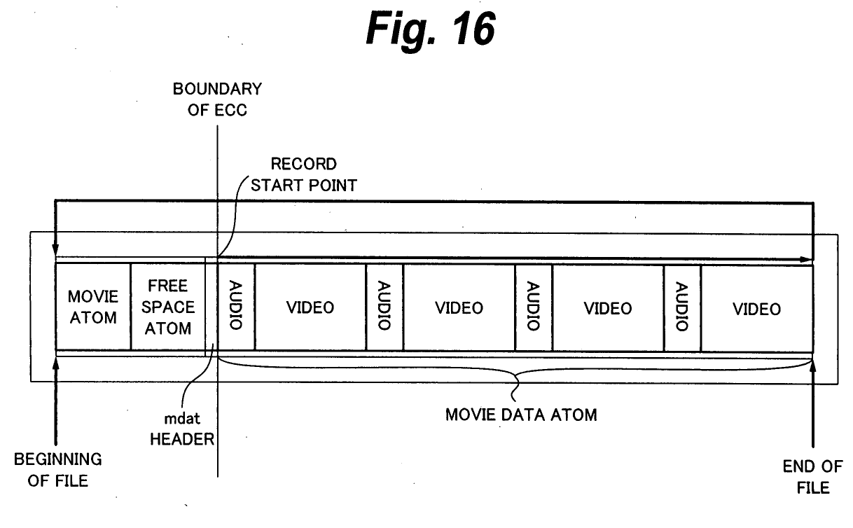

Next, with reference to a schematic diagram and flow chart shown in FIG. 16 and FIG. 17, respectively, a process of generating a file of the foregoing AV multiplex format will be described.

First, with reference to FIG. 16, a process of generating a regular QT file will be described. As shown in FIG. 16, in the QT file, a movie data atom composed of chunks of audio data (Audio) and video data (Video) is recorded from the boundary of a particular ECC to the right of the drawing. After the movie data atom has been recorded, in the QT file, a movie atom is generated according to chunks of the movie data atom and the generated movie atom is recorded from the beginning of the file. After the movie atom has been recorded, a free space atom and an mdat header are recorded so that the end of the mdat header matches the boundary of an ECC.

In the QT file, after the movie data atom, the movie atom and the free space atom are physically recorded. As a result, an QT file is generated. In the QT file, the beginning of the file that has been recorded is logically the movie atom on the left side of the drawing. The end of the file is logically the end of the movie data atom on the right side of the drawing.

A process of generating a file of the AV multiplex format described with reference to FIG. 17 is basically executed according to the process of generating the regular QT file described with reference to FIG. 16.

The image sensor section 31 of the picture record device 1 captures an image of an object and supplies the video data of the captured image to the video encode section 15. The video encode section 15 encodes the video data inputted from the image sensor section 31 according to the MPEG4 system and supplies the encoded data to the file generation section 22. On the other hand, the microphone 32 supplies collected audio data to the audio encode section 16. The audio encode section 16 encode the audio data inputted from the microphone 32 according to the ITU-T G.711 A-Law system and supplies the encoded audio data to the file generation section 22.

At step S1, the file generation section 22 alternately multiplexes video data supplied from the video encode section 15 and audio data supplied from the audio encode section 16 for 60 frames of video data each at a time (in the case of the NTSC system). Thereafter, the file generation section 22 generates the file body portion of the AV multiplex format described with reference to FIG. 11 to FIG. 15. At step S2, the file generation section 22 obtains the frame size of the video data of the generated file body portion and stores the frame size in an internal memory (not shown). Thereafter, the flow advances to step S3.

At step S3, the file generation section 22 supplies the generated file body portion of the AV multiplex format to the drive 23 and records it to the storage section 20. Thereafter, the flow advances to step S4. At this point, the file generation section 22 calculates ECCs for which the file header portion is recorded, determines the boundary of a predetermined ECC as the record start point of the file body portion according to the calculated ECCs, and records the file body portion starting from the record start point to the storage section 20.

AT step S4, the drive 23 records the file body portion supplied from the file generation section 22 to the optical disc 2. Thereafter, the flow advances to step S5. Specifically, the drive 23 calculates ECCs for which the file header portion is recorded, determines the boundary of a predetermined ECC as the record start point of the file body portion according to the calculated ECCs, and records the file body portion starting from the record start point to the optical disc 2.

At step S5, the file generation section 22 executes the process of generating the file footer portion and the file header portion. Thereafter, the flow advances to step S6. Next, the process of generating the file footer portion and the file header portion will be described with reference to a flow chart shown in FIG. 18.

Parameter information with which the file body portion was recorded at step S3 or S4 shown in FIG. 17 is recorded in the RAM 13. The parameter information is composed of information that identifies NTSC or PAL, the number of ECCs with which audio data were recorded, the number of ECCs with which video data were recorded, the duration for which the body portion was recorded, the number of frames that were recorded, pointer information that represents the first frame, and so forth.

At step S21 shown in FIG. 18, the file generation section 22 obtains the parameter information from the RAM 13. Thereafter, the flow advances to step S22. At step S22, the file generation section 22 sets internal parameters according to the obtained parameter information and the frame size recorded at step S2 shown in FIG. 17. Thereafter, the flow advances to step S23. The internal parameters are composed of for example size information of a GOP, time information such as time scale, and so forth.

At step S23, the file generation section 22 generates the file footer portion according to the internal parameters that were set and writes the file footer portion to the internal memory. Thereafter, the flow advances to step S24. At steps S24 to S26, the file generation section 22 generates the file header portion.

In other words, at step S24, the file generation section 22 generates the MXF header of the file header portion according to the internal parameters that were set and writes the MXF header to the internal memory. Thereafter, the flow advances to step S25. At step S25, the file generation section 22 sets the sample tables of each track atom of the movie atom according to the internal parameters that were set. Thereafter, the flow advances to step S26. At step S26, the file generation section 22 calculates the atom size according to the set values of each of the sample tables, generates the movie atom, and writes it to the internal memory. Thereafter, the flow returns to step S6 shown in FIG. 17.

Next, the process of step S26 will be specifically described. The file generation section 22 generates the QT header composed of the skip atom and the movie atom of hierarchical level 1 and the movie header atom of hierarchical level 2 shown in FIG. 6 and writes the QT header to the internal memory. Thereafter, the file generation section 22 generates the video atom composed of the track atom of hierarchical level 2 and the atoms of hierarchical level 3 to hierarchical level 8 and writes the video atom to the internal memory. Thereafter, the file generation section 22 generates the audio atom composed of the track atom of hierarchical level 2 and the atoms of hierarchical level 3 to hierarchical level 8 and writes the audio atom to the internal memory. Last, the file generation section 22 generates the QT trailer composed of the user definition atom of hierarchical level 2 and the free space atom (free) and the mdat header of hierarchical level 1 and writes the QT trailer to the internal memory.

As described above, at steps S24 to S26, the file header portion containing the MXF header and the movie atom is generated.

At step S6 shown in FIG. 17, the file generation section 22 supplies the file footer portion generated at step S5 to the drive 23 and records the file footer portion to the storage section 20. Thereafter, the flow advances to step S7. At this point, the file generation section 22 connects the file footer portion to the end of the file body portion recorded in the storage section 20 at step S2 and records the resultant data to the storage section 20.

At step S7, the drive 23 records the file footer portion supplied from the file generation section 22 to the optical disc 2. Thereafter, the flow advances to step S8. Specifically, the drive 23 connects the file footer portion to the end of the file body portion recorded on the optical disc 2 at step S3 and records the resultant data to the optical disc 2.

At step S8, the file generation section 22 supplies the MXF header generated at step S5 and the file header portion containing the movie atom to the drive 23 and records them to the storage section 20. Thereafter, the flow advances to step S9. At this point, the file generation section 22 connects the file header portion to the beginning of the file body portion recorded in the storage section 20 and records the resultant data to the storage section 20. As a result, a file of the AV multiplex format is generated.

At step S9, the drive 23 records the MXF header and the file header portion containing the movie atom supplied from the file generation section 22 to the optical disc 2. As a result, the file generation and record process is completed. Specifically, the drive 23 connects the file header portion to the beginning of the body portion recorded on the optical disc 2 and records the resultant data to the optical disc 2. As a result, a file of the AV multiplex format is recorded on the optical disc 2.

In such a manner, the file of the AV multiplex format is generated. The CPU 11 controls the communication section 21 to transmit the file of the AV multiplex format generated in the storage section 20 to the edit device 6 and PC 7 through the network 5. Thus, the picture record device 1 can exchange the file of the AV multiplex format with the edit device 6 and the PC 7.

Since the file of the AV multiplex format is recorded on the optical disc 2 in such a manner, the picture record device 1 can exchange the file of the AV multiplex format with the edit device 3 and the PC 4 through the optical disc 2.

In other words, the picture record device 1, the MXF standard basis edit devices 3 and 6, and the QT software installed PCs 4 and 7 can exchange files of the AV multiplex format thereamong.

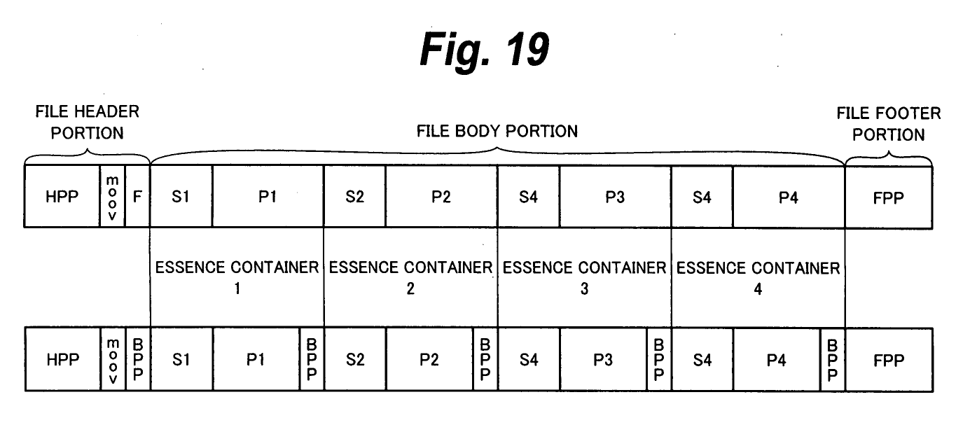

FIG. 19 shows another example of the file of the AV multiplex format. In the example shown in FIG. 19, the AV multiplex format is composed of a file header portion, a file body portion, and a file footer portion. The file header portion is composed of a header partition pack (HPP), a movie atom (moov) and a filler (F). The file footer portion is composed of a footer partition pack (FPP).

As shown in the upper sequence, it is assumed that the file body portion is composed of a plurality of essence containers such as essence container 1 composed of sound item S1 and picture item P1; essence container 2 composed of sound item S2 and picture item P2; essence container 3 composed of sound item S3 and picture item P3; and essence container 4 composed of sound item S4 and picture item P4.

However, the MXF standard restricts the number of essence containers to one per clip (edit unit). Thus, when a plurality of essence containers are placed in the file body portion, it is necessary to place a body partition pack (BPP) followed by each sound item and preceded by each picture item. Each body partition pack describes an offset value from the beginning of the file and an offset value of the preceding body partition pack.

Thus, as shown in the lower sequence, the body partition pack is placed in each of the filer of the header portion, a filer (not shown) of picture item P1, a filer (not shown) of picture item P2, a filer (not shown) of picture item P3, and a filer (not shown) of picture item P4. The body partition pack of the header portion describes an offset value from the beginning of the file to the body partition pack of the header portion. The body partition pack of picture item P1 describes an offset value from the beginning of the file to the body partition pack of picture item P1 and an offset value of the preceding body partition pack (namely, the offset value of the body partition pack of the header portion).

The body partition pack of the picture item P2 describes an offset value from the beginning of the file to the body partition pack of picture item P2 and an offset value of the preceding body partition pack (namely, the offset value of the body partition pack of picture item P1). The body partition pack of picture item P3 describes an offset value from the beginning of the file to the body partition pack of picture item P3 and an offset value of the preceding body partition pack (namely, the offset value of the body partition pack of picture item P2). The body partition pack of picture item P4 describes an offset value from the beginning of the file to the body partition pack of picture item P4 and an offset value of the preceding body partition pack (namely, the offset value of the body partition pack of picture item P3).

As described above, when a body partition pack that describes an offset value of the body partition pack itself and an offset value of the preceding partition pack is placed in each essence container, the range of each essence container can be recognized. Thus, in the AV multiplex format, a plurality of essence containers can be placed in the file body portion.

In the foregoing, the movie atom is placed in the file header portion of the AV multiplex format. In this case, since the movie atom is placed on the top side of the file, the QT software installed PCs 4 and 7 can readily read the sample tables of the movie atom. Thus, the PCs 4 and 7 can effectively access video data and audio data recorded in the movie atom. However, the lengths of the sample tables of the movie atom vary with the record duration.

Thus, when the movie atom whose length is not constant is placed in the file header portion of the AV multiplex format, although the offset value from the beginning of the file to each body partition pack should be described therein as explained with reference to FIG. 19, the offset value cannot be decided until the end. In other words, in the AV multiplex format of which the movie atom is placed in the file header portion, a plurality of essence containers cannot be placed in the file body portion.

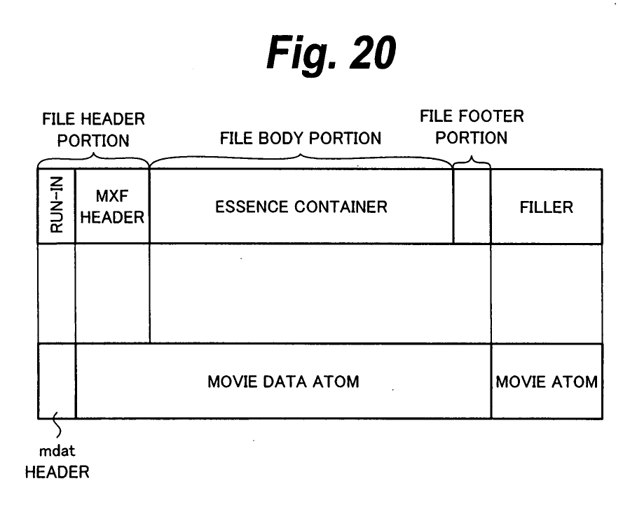

To solve this problem, with reference to FIG. 20, an example of which the movie atom is placed at the end of the file footer portion of the AV multiplex format will be described.

FIG. 20 shows another example of the AV multiplex format. In the example shown in FIG. 20, the upper sequence shows an example of a file of the AV multiplex format regarded as an MXF file. The lower sequence shows an example of a file of the AV multiplex format regarded as a QT file.

In the example shown in FIG. 20, as shown in the upper sequence, when a file of the AV multiplex format is regarded as an MXF file, the file of the AV multiplex format is composed of a file header portion, a file body portion, a file footer portion, and a filler. The file header portion is composed of a run-in of 8 bytes and an MXF header. The file body portion composed of an essence container. As shown in the lower sequence, when a file of the AV multiplex format is regarded as a QT file, the file of the AV multiplex format is composed of a mdat header that is a header of a movie data atom, a movie data atom (moviedata atom), and a movie atom (movie atom) that are successively arranged.

In other words, in the file of the AV multiplex format shown in FIG. 20, the mdat header of the QT is described at the beginning corresponding to the run-in that is ignored in the MXF file. In addition, since the offset value of a chunk described in the chunk offset atom of the movie atom is set to AV data placed in the essence container of the file body portion of the MXF, the MXF header can be described in the movie atom. In addition, the movie atom of the QT is described in the filler preceded by the file footer portion. The filler is ignored in the MXF.

In this structure, the MXF standard basis edit devices 3 and 6 ignore the run-in, find the pattern of 11 bytes, and obtain the MXF header. According to header meta data of the MXF header, the edit devices 3 and 6 can read video data and audio data that are AV data placed in the essence container.

On the other hand, the QT software installed PCs 4 and 7 can read the movie atom and chucks (audio data or video data) recorded in the file body portion of the MXF, the file body portion being followed by the movie atom according to information to use information recoded in the movie data atom described in the movie atom.

In the AV multiplex format shown in FIG. 20, since the movie atom is placed after the file footer portion of the MXF, even if the lengths of the sample tables of the movie atom vary with the record duration, the offset value, which is from the beginning of the file for each body partition pack, to be described therein as explained with reference to FIG. 19 does not vary. Thus, in the AV multiplex format of which the movie atom is placed after the file footer portion, a plurality of essence containers can be placed in the file footer portion.

Next, with reference to a flow chart shown in FIG. 21, a process of generating a file of the AV multiplex format shown in FIG. 20 will be described. Since the process at steps S61 to S65 shown in FIG. 21 is basically the same as that at step S1 to S5 shown in FIG. 17, to prevent redundancy, their description will be omitted.

At step S61, the file generation section 22 alternately multiplexes video data supplied from the video encode section 15 and audio data supplied from the audio encode section 16 for 60 frames of video data each at a time-(in the case of the NTSC system) and generates the file body portion of the AV multiplex format described with reference to FIG. 20. In addition, at step S62, the file generation section 22 obtains the frame size of video data of the generated file body portion and stores the frame size to the internal memory (not shown). Thereafter, the flow advances to step S63.

At step S63, the file generation section 22 supplies the generated file body portion of the AV multiplex format to the drive 23 and records it to the storage section 20. Thereafter, the flow advances to step S64. At step S64, the drive 23 records the file body portion supplied from the file generation section 22 to the optical disc 2. Thereafter, the flow advances to step S65. At step S65, the file generation section 22 executes the generation process for the file footer portion and the file header portion described with reference to FIG. 18. Thereafter, the flow advances to step S66.

At step S66, the file generation section 22 supplies the file footer portion and the movie atom generated at step S65 to the drive 23 and records them to the storage section 20. Thereafter, the flow advances to step S67. At this point, the file generation section 22 connects the file footer portion and the movie atom to the end of the file body portion recorded in the storage section 20 at step S62 and records the resultant data to the storage section 20.

At step S67, the drive 23 records the file footer portion supplied from the file generation section 22 to the optical disc 2. Thereafter, the flow advances to step S68. Specifically, at step S63, the drive 23 connects the file footer portion and the movie atom to the end of the body portion recorded on the optical disc 2 at step S63 and records the resultant data to the optical disc 2.

At step S68, the file generation section 22 supplies the file header portion containing the MXF header generated at step S65 to the drive 23 and records the file header portion to the storage section 20. Thereafter, the flow advances to step S9. At this point, the file generation section 22 connects the header portion to the beginning of the file body portion recorded in the storage section 20 and records the resultant data to the storage section 20. As a result, a file of the AV multiplex format is generated.

At step S69, the drive 23 records the file header portion supplied from the file generation section 22 to the optical disc 2. As a result, the file generation and record process is completed. Specifically, the drive 23 connects the file header portion to the beginning of the file body recorded on the optical disc 2 and records the resultant data to the optical disc 2. As a result, the file of the AV multiplex format is recorded on the optical disc 2.

In such a manner, the file of the AV multiplex format shown in FIG. 20 is generated. The CPU 11 controls the communication section 21 to transmit the file of the AV multiplex format generated in the storage section 20 to the edit device 6 and the PC 7 through the network 5. Thus, the picture record device 1 can exchange the file of the AV multiplex format shown in FIG. 20 with the edit device 6, the PC 7, and so forth.

In addition, in the foregoing manner, the file of the AV multiplex format is recorded on the optical disc 2. Thus, the picture record device 1 can exchange the file of the AV multiplex format shown in FIG. 20 with the edit device 3, the PC 4, and so forth though the optical disc 2.

In other words, the MXF standard basis edit devices 3 and 6, and the QT software installed PCs 4 and 7 can exchange the file of the AV multiplex format shown in FIG. 20 thereamong.

FIG. 22 shows another example of the structure of the AV network system according to the present invention. In FIG. 22, sections corresponding to the AV network system shown in FIG. 1 are denoted by corresponding reference numerals and their description will be omitted to prevent redundancy.

In the example shown in FIG. 22, the picture record device 1 has a QT software installed PC 104. The picture record device 1 is carried and installed at a reporting site to input sound, capture pictures, and record them.

The image sensor section 31 of the picture record device 1 captures an image of an object and supplies video data of the captured image to the video encode section 15. The video encode section 15 encodes video data inputted from the image sensor section 31, obtains high resolution video data that are broadcast from a broadcasting station and low resolution video data for communication and editing, and supplies these two types of video data to the file generation section 22. On the other hand, the microphone 32 supplies the collected audio data to the audio encode section 16. The audio encode section 16 encodes the audio data inputted from the microphone 32, obtains high quality audio data that are broadcast from the broadcasting station and low quality audio data for communication and editing, and supplies these two types of audio data to the file-generation section 22.

The file generation section 22 generates high quality and low quality files of the AV multiplex format with the high resolution and low resolution video data supplied from the video encode section 15 and the high quality and low quality audio data supplied from the audio encode section 16 and controls the drive 23 to record the generated files of the AV multiplex format to the optical disc 2. The encoded video data and audio data are recorded to the optical disc 2 while they are being collected (captured). Instead, the encoded video data and audio data may be temporarily recorded to the storage section 20. The encoded video data and audio data may be read from the storage section 20. Thereafter, files of the AV multiplex format may be generated with the encoded video data and audio data and recorded to the optical disc 2.

In addition, while the file generation section 22 is supplying the file of the AV multiplex format to the drive 23, the file generation section 22 generate a low quality file of the AV multiplex format with the low resolution video data supplied from the video encode section 15 and the low resolution audio data supplied from the audio encode section 16 and temporarily stores the generated file to the storage section 20. The CPU 11 controls the communication section 21 to transmit the low quality file of the AV multiplex format recorded in the storage section 20 to a broadcasting station 102 through a communication satellite 101.

The broadcasting station 102 has an edit device 103. The broadcasting station 102 receives the low quality file of the AV multiplex format from the picture record device 1 and supplies the received low quality file of the AV multiplex format to the edit device 103.

Like the edit devices 3 and 6 shown in FIG. 1, the edit device 103 is an MXF standard basis device. The edit device 103 recognizes the low quality file of the AV multiplex format received from the broadcasting station 102. In addition, the edit device 103 edits audio data and video data of the low quality AV multiplex format so that their durations match a predetermined broadcast duration, performs a picture process of changing scenes, and performs an edit operation that creates text data associated with a script or the like. The edit device 103 transmits the edited contents of audio data and video data of the low quality AV multiplex format as an edit list or the like to the picture record device 1 through the communication satellite 101.

Instead, the picture record device 1 may transmit the file of the low quality AV multiplex format to a PC 104 that is disposed adjacent to the edit device and that allows a producer or the like to edit the file while he or she is checking the recording state.

The PC 104 has the same structure as the PC 4 and the PC 7 shown in FIG. 1. Thus, the PC 104 has installed the QT software. As a result, the PC 104 can check and edit the low resolution file of the AV multiplex format transmitted from the picture record device 1 according to the QT. The PC 104 transmits the edited contents of the low quality audio data and video data of the AV multiplex format as an edit list to the picture record device 1 through the communication satellite 101 or a short distance wireless communication such as Bluetooth (registered trademark). In other words, even if there is no dedicated edit device 103, which is expensive, at a reporting site, the PC 104, which is a general purpose and portable device, can check and edit the low resolution file of the AV multiplex format.

The communication section 21 of the picture record device 1 receives the edit list from the edit device 103 or the PC 104. The CPU 11 controls the drive 23 to record the edit list supplied from the communication section 21 to the optical disc 2. At this point, the edit list is recorded to for example header meta data of the file header portion. After the high quality and low quality files of the AV multiplex format and the edit list have been recorded to the optical disc 2, it is carried to the broadcasting station 102.

In the broadcasting station 102, the edit device 103 reads the high resolution video data and high quality audio data from the optical disc 2, decodes them, and broadcasts (airs) the decoded data according to the edit list recorded on the optical disc 2.

In the foregoing example, a low quality file and a high quality file of the AV multiplex format are recorded on the optical disc 2. Instead, one file (for example, a high quality file of the AV multiplex format) may be recorded on the optical disc 2, whereas the other file (for example, a low quality file of the AV multiplex format) may be recorded to anther record medium such as a memory card having a semiconductor memory.

In the foregoing example, the broadcasting station 102 has the edit device 103. Instead, the broadcasting station 102 may have the PC 104 instead of the edit device 103. At a reporting site, the edit device 103 may be used instead of the PC 104.

Next, with reference to a flow chart shown in FIG. 23, the process of the AV network system shown in FIG. 22 will be described. In FIG. 23, the processes of the picture record device 1 and the PC 104 will be described. The process of the AV network system may be performed by the PC 104 instead of the edit device 103.

The image sensor section 31 of the picture record device 1 captures an image of an object and supplies video data of the captured image to the video encode section 15. The video encode section 15 encodes the video data inputted from the image sensor section 31, obtains high resolution and low resolution encoded video data, and supplies the two types of encoded video data to the file generation section 22. On the other hand, the microphone 32 supplies collected audio data to the audio encode section 16. The audio encode section 16 encodes the audio data inputted from the microphone 32, obtains high quality and low quality encoded audio data, and supplies the two types of obtained encoded data to the file generation section 22.

At step S101, the file generation section 22 of the picture record device 1 generate an AV multiplex format with the video data and audio data and controls the drive 23 to record the AV multiplex format to the optical disc 2. In addition, the file generation section 22 controls the drive 23 to record the generated AV multiplex format to the storage section 20. Thereafter, the flow advances to step S102.

Specifically, the file generation section 22 generates a high quality file and a low quality file of the AV multiplex format with the high and low resolution video data supplied from the video encode section 15 and the high quality and low quality audio data supplied from the audio encode section 16 and controls the drive 23 to record the generated files of the AV multiplex format to the optical disc 2. In addition, the file generation section 22 generates a low quality file of the AV multiplex format with the low resolution video data supplied from the video encode section 15 and the low resolution audio data supplied from the audio encode section 16 and temporarily stores the low quality file of the AV multiplex format to the storage section 20.

At step S102, the CPU 11 of the picture record device 1 controls the communication section 21 to transmit the low quality file of the AV multiplex format recoded in the storage section 20 to the PC 104 through for example a short distance wireless communication.

On the other hand, at step S121, the PC 104 receives the low quality file of the AV multiplex format and edits the low quality audio data and video data of the AV multiplex format according to the QT. Thereafter, the flow advances to step S122. At step S122, the PC 104 transmits the edited contents of the low quality audio data and video data of the AV multiplex format as an edit list to the picture record device 1 through the short distance wireless communication.

At step S103, the communication section 21 of the picture record device 1 receives the edit list from the PC 104. Thereafter, the flow advances to step S104. At step S104, the PC 104 records the received edit list to the optical disc 2.

The optical disc 2 is carried to the broadcasting station 102. In the broadcasting station 102, high resolution video data and high quality audio data are read from the optical disc 2. The high resolution video data and high quality audio data are decoded. The decoded data are broadcast according to the edit list recorded on the optical disc 2.

As described above, since the AV multiplex format is used, even if the PC 104, which is a general-purpose and portable device, can check and edit the files of the AV multiplex format without need to use the edit device 103, which is an expensive and dedicated device, at a reporting site. In addition, when a low quality file of the AV multiplex format is used, the loads of communication and editing can be lightened.

Thus, the time after data are recorded until they are broadcast can be shortened. In addition, since the PC 104 can be used, the cost necessary to record data can be reduced.

According to this embodiment of the present invention, the picture record device 1 reads and writes files of the AV multiplex format from and to the optical disc 2. Instead, files of the AV multiplex format may be read and written from and to a tape-shaped record medium such as a magnetic tape, a semiconductor memory, or the like.

The foregoing processes can be executed by hardware. Instead, they may be executed by software. When they are executed by software, a program that composes the software is installed from a program storage medium to a computer that is provided with dedicated hardware or a general-purpose personal computer that can execute various functions.

The program storage medium that stores the program that is installed to the computer and that is executed thereby is composed of a package media that is for example the optical disc 2 shown in FIG. 2 or the storage section 20 that temporarily or permanently stores the program.

In this specification, steps that describe the program recorded on the record medium include a process that is preformed in time series and in the described order and a process that is not performed in time series, but in parallel or discretely.

In this specification, the system represents an entire apparatus composed of a plurality of devices.

As described above, according to the present invention, files can be exchanged between a broadcast device and a personal computer.

1-16. (canceled)

17. An information process apparatus that generates a file of a first format composed of a header portion, a body portion, and a footer portion, comprising:
body generation means for generating the body portion with input data;
obtainment means for obtaining the size of the input data;
table generation means for generating table information with which the input data are read as a file of a second format from the body portion according to the size obtained by the obtainment means;
header generation means for describing a header of a skip area of the second format in a beginning area of the header portion ignored in the first format, describing a header of the body portion of the first format in the skip area of the second format, and describing the table information generated by the table generation means and a header of a data area of the second format in an area ignored in the first format, the body portion being contained in the data area, to generate the header portion; and
file generation means for connecting the footer portion to the end of the body portion and connecting the header portion generated by the header generation means to the beginning of the body portion to generate the file.

18. The information process apparatus as set forth in claim 17,
wherein the first format is MXF (Material exchange Format) and the second format is QT (Quick Time) format.

19. The information process apparatus as set forth in claim 17,
wherein the input data is lower resolution data than main data.

20. The information process apparatus as set forth in claim 17, further comprising:
body record means for recording the body portion generated by the body generation means to a record medium;
footer record means for recording the footer portion after the body portion recorded on the record medium by the body record means; and
header record means for recording the header portion before the body portion recorded on the record medium by the body record means.

21. The information process apparatus as set forth in claim 17, further comprising:
transmission means for transmitting the file generated by the file generation means to another information process apparatus through a network;
reception means for receiving meta data according to the file transmitted by the transmission means from the other information process apparatus through the network; and
meta data record means for recording the meta data received by the reception means to the record medium.

22. An information process method of generating a file of a first format composed of a header portion, a body portion, and a footer portion, comprising the steps of:
generating the body portion with input data;
obtaining the size of the input data;
generating table information with which the input data are read as a file of a second format from the body portion according to the size obtained by a process of the obtainment step;
describing a header of a skip area of the second format in a beginning area of the header portion ignored in the first format, describing a header of the body portion of the first format in the skip area of the second format, and describing the table information generated by a process of the table generation step and a header of a data area of the second format in an area ignored in the first format, the body portion being contained in the data area, to generate the header portion; and
connecting the footer portion to the end of the body portion and connecting the header portion generated by a process of the header generation step to the beginning of the body portion to generate the file.

23. A program record medium on which a program that is readable by a computer is recorded, the program causing the computer to perform an information process of generating a file of a first format composed of a header portion, a body portion, and a footer portion, the information process comprising the steps of:
generating the body portion with input data;
obtaining the size of the input data;
generating table information with which the input data are read as a file of a second format from the body portion according to the size obtained by a process of the obtainment step;
describing a header of a skip area of the second format in a beginning area of the header portion ignored in the first format, describing a header of the body portion of the first format in the skip area of the second format, and describing the table information generated by a process of the table generation step and a header of a data area of the second format in an area ignored in the first format, the body portion being contained in the data area, to generate the header portion; and
connecting the footer portion to the end of the body portion and connecting the header portion generated by a process of the header generation step to the beginning of the body portion to generate the file.

24. A program that causes a computer to perform an information process of generating a file of a first format composed of a header portion, a body portion, and a footer portion, the information process comprising the steps of:
generating the body portion with input data;
obtaining the size of the input data;
generating table information with which the input data are read as a file of a second format from the body portion according to the size obtained by a process of the obtainment step;
describing a header of a skip area of the second format in a beginning area of the header portion ignored in the first format, describing a header of the body portion of the first format in the skip area of the second format, and describing the table information generated by a process of the table generation step and a header of a data area of the second format in an area ignored in the first format, the body portion being contained in the data area, to generate the header portion; and
connecting the footer portion to the end of the body portion and connecting the header portion generated by a process of the header generation step to the beginning of the body portion to generate the file.

25. An information process apparatus that generates a file of a first format composed of a header portion, a body portion, and a footer portion, comprising:
body generation means for generating the body portion with input data;
obtainment means for obtaining the size of the input data;
table generation means for generating table information with which the input data are read as a file of a second format from the body portion according to the size obtained by the obtainment means;
header generation means for describing a header of a data area of the second format in a beginning area of the header portion ignored in the first format, the body portion being contained in the data area, and describing a header of the body portion of the first format in a beginning area of the data area to generate the header portion; and
file generation means for connecting the footer portion and the table information generated by the table generation means to the end of the body portion and connecting the header portion to the beginning of the body portion to generate the file.

26. The information process apparatus as set forth in claim 25,
wherein the first format is MXF (Material exchange Format) and the second format is QT (Quick Time) format.

27. The information process apparatus as set forth in claim 25,
wherein the input data is lower resolution data than main data.

28. The information process apparatus as set forth in claim 25, further comprising:
body record means for recording the body portion generated by the body generation means to a record medium;
footer record means for recording the footer portion and the table information after the body portion recorded on the record medium by the body record means; and
header record means for recording the header portion before the body portion recorded on the record medium by the body record means.

29. The information process apparatus as set forth in claim 25, further comprising:
transmission means for transmitting the file generated by the file generation means to another information process apparatus through a network;
reception means for receiving meta data according to the file transmitted by the transmission means from the other information process apparatus through the network; and
meta data record means for recording the meta data received by the reception means to the record medium.

30. An information process method of generating a file of a first format composed of a header portion, a body portion, and a footer portion, comprising the steps of:
generating the body portion with input data;
obtaining the size of the input data;
generating table information with which the input data are read as a file of a second format from the body portion according to the size obtained by a process of the obtainment step;
describing a header of a data area of the second format in a beginning area of the header portion ignored in the first format, the body portion being contained in the data area, and describing a header of the body portion of the first format in a beginning area of the data area to generate the header portion; and
connecting the footer portion and the table information generated by a process of the table generation step to the end of the body portion and connecting the header portion to the beginning of the body portion to generate the file.

31. A program record medium on which a program that is readable by a computer is recorded, the program causing the computer to perform an information process of generating a file of a first format composed of a header portion, a body portion, and a footer portion, the information process comprising the steps of:
generating the body portion with input data;
obtaining the size of the input data;
generating table information with which the input data are read as a file of a second format from the body portion according to the size obtained by a process of the obtainment step;
describing a header of a data area of the second format in a beginning area of the header portion ignored in the first format, the body portion being contained in the data area, and describing a header of the body portion of the first format in a beginning area of the data area to generate the header portion; and
connecting the footer portion and the table information generated by a process of the table generation step to the end of the body portion and connecting the header portion to the beginning of the body portion to generate the file.

32. A program that causes a computer to perform an information process of generating a file of a first format composed of a header portion, a body portion, and a footer portion, the information process comprising the steps of:
generating the body portion with input data;
obtaining the size of the input data;
generating table information with which the input data are read as a file of a second format from the body portion according to the size obtained by a process of the obtainment step;
describing a header of a data area of the second format in a beginning area of the header portion ignored in the first format, the body portion being contained in the data area, and describing a header of the body portion of the first format in a beginning area of the data area to generate the header portion; and
connecting the footer portion and the table information generated by a process of the table generation step to the end of the body portion and connecting the header portion to the beginning of the body portion to generate the file.
